(19) United States
(12) Patent Application Publication
(10) Pub. No.: US 2013/0294467 A1
(43) Pub. Date: Nov. 7, 2013

(54) LASER-BASED SOURCE FOR TERAHERTZ AND MILLIMETER WAVES

(71) Applicants: Jerome V. Moloney, Tucson, AZ (US); Mahmoud Fallahi, Tucson, AZ (US); Stephan W. Koch, Fronhausen (DE); Martin Koch, Kirchhaln (DE); Maik Scheller, Braunschweig (DE); Kai Baaske, Cremlingen (DE)

(72) Inventors: Jerome V. Moloney, Tucson, AZ (US); Mahmoud Fallahi, Tucson, AZ (US); Li Fan, Tucson, AZ (US); Stephan W. Koch, Fronhausen (DE); Martin Koch, Kirchhaln (DE); Maik Scheller, Braunschweig (DE); Kai Baaske, Cremlingen (DE)

(21) Appl. No.: 12/643,618

(22) Filed: Dec. 21, 2009

Related U.S. Application Data
(63) Continuation-in-part of application No. 12/285,856, filed on Oct. 15, 2008, now abandoned.
Application No. 12/285,856 is a continuation-in-part of application No. 12/397,139, filed on Mar. 3, 2009, now abandoned.
(60) Provisional application No. 60/999,009, filed on Oct. 15, 2007.
(60) Provisional application No. 61/067,949, filed on Mar. 3, 2008.

(30) Foreign Application Priority Data
Apr. 30, 2008 (DE) DE102008021791.3

(51) Int. Cl. H01S 3/10

(52) U.S. Cl. CPC H01S 3/10
USPC 372/20

(57) ABSTRACT

A multi-wavelength VECSEL includes an active region comprising a plurality of semiconductor quantum wells having an intrinsically broadened gain with a wavelength selective filter disposed within the cavity to provide a laser output that oscillates at two or more separated wavelengths simultaneously. A non-linear crystal may be provided in the cavity to emit radiation at a frequency in the THz range that is the difference of the frequencies associated with two of the separated wavelengths.

### RELATED APPLICATIONS

This application is a continuation-in-part of U.S. patent application Ser. No. 12/285,856, filed on Oct. 15, 2008, which claims the benefit of priority of U.S. Provisional Application No. 60/999,009, filed on Oct. 15, 2007, the entire contents of which application(s) are incorporated herein by reference. This application is a also continuation-in-part of U.S. patent application Ser. No. 12/397,139, filed on Mar. 3, 2009, which claims the benefit of priority of U.S. Provisional Application No. 61/067,949, filed on Mar. 3, 2008, and claims the benefit of priority of German Patent Application DE102008021791.3, filed on Apr. 30, 2008, the entire contents of which applications are incorporated herein by reference.

### GOVERNMENT LICENSE RIGHTS

This invention was made with United States Government support under the USAF/AFOSR contract No. F49620-02-1-0380. The United States Government has certain rights in this invention.

### FIELD OF THE INVENTION

The present invention relates generally to a tunable dual wavelength vertical external cavity surface emitting laser and also to a terahertz and millimeter wave source, and more particularly, but not exclusively, to structures for coupling the terahertz electromagnetic waves out of the source.

### BACKGROUND OF THE INVENTION

Terahertz (THz) waves, with a frequency range of 0.1-10 THz, called T-rays, occupy a large portion of the electromagnetic spectrum between the infrared and microwave bands (FIG. 1). The terahertz frequency range is located between those of microwaves and infrared light. Thus, THz waves can be considered either as very high-frequency microwaves or as very long-wave light (far-infrared radiation). While all the other ranges of the electromagnetic spectrum are technologically used, the far-infrared spectrum of the terahertz frequencies forms a blank area on the electromagnetic map (see FIG. 1). The reason for this is the lack of efficient, cost-effective and compact THz emitters and receivers.

One of the unique properties of THz radiation is its ability to pass through a wide range of materials, thus making it possible to ‘see through’ many packaging materials such as paper, plastics, and wood. This property allows a nondestructive and noninvasive inspection of mail packages and envelopes in post offices and luggage. In comparison with x-ray inspection techniques, THz waves provide a better contrast for soft matter. THz frequency is more sensitive to the nature of the materials it passes through and is more selective compared to x-rays. This property works in conjunction with the absorption property of various materials at specific THz range. By analyzing the frequency dependence of the transmission or reflection intensity, each substance presents a particular behavior, which allows what is called “fingerprinting or signature”, that is, assigning a spectral characteristic to each chemical. Spectral fingerprints are essential in the process of identifying the chemicals in an unknown target, used in biomedical research and explosives detection. In addition, as THz waves possess a much smaller wavelength than classical microwaves, they are suitable for achieving spatial resolutions of less than one millimeter. This makes them interesting for many imaging applications in a whole variety of areas. This includes both security checks of persons, letters and luggage, as well as the control of completeness of packaged goods or the process control during the production of polymer composite materials. Furthermore, the “in-door” communication through THz waves promises to become a mass market from approx. 2015 onwards.

The past 20 years have seen a revolution in THz systems and their applications. THz spectroscopy and imaging has been applied to material science, physics, electrical engineering and chemistry. Potential applications in biology and medicine are now beginning to emerge. THz technology is becoming an extremely attractive research field, with interest from sectors as diverse as the semiconductor, medical, manufacturing, and defense industries. Several recent developments include the demonstration of THz detection of single base-pair differences in femtomolar concentrations of DNA, the investigation of the evolution of multi-particle charge interactions with THz spectroscopy and THz imaging with nanometer resolution.

In exchange for the obvious advantages offered by the THz frequency range several practical drawbacks exits. Most of the instruments used in THz research have large dimensions and heavy weight, and require special operating conditions such as very low temperature, controlled humidity, etc. which make it hard to easily deploy THz systems in real-life applications. Coherent, tunable continuous-wave (CW) THz sources are strongly needed in many applications such as high-resolution spectroscopy and imaging, heterodyne receiver systems, local area networks, and various methods have been investigated. Coherent THz wave signals are detected in the time domain by mapping the transient of the electric field in amplitude and phase.

The conventional coherent tunable THz sources include: optical down-converters by photomixing, optical parametric oscillators (OPO), difference frequency generation (DFG), and four wave mixing; free electron laser; synchrotrons; optically pumped THz lasers; and quantum cascade laser. However each of these devices suffers from at least one of the drawbacks in power, operation condition, tuning range, physical size, and cost. The lack of a high-power, low-cost, portable room temperature THz source is one of the most significant limitations of modern THz systems.

Recently considerable effort has been devoted to the generation of tunable coherent THz radiation by optical down-converters (OPO or DFG) from infrared (IR) radiation. The advantage of these methods is the room temperature operation. However, the tunable coherent IR pump sources are needed. Diode pumped solid-state lasers (DPSL) or fiber lasers are usually used as a pumped source for THz generation. Multi-stage optical setup (DPSL>Frequency conversion (tunable IR)>Frequency conversion (tunable THz)) has to be used in the generation of THz radiation. The final pump emission applied to nonlinear crystal to generate THz passes through the nonlinear crystal with a single pass. Since the optical (IR) to THz conversion efficiency is very low (˜10⁻⁵) and the power of final pump emission is limited, these THz-wave sources are very low-power with CW output power of around μW and pulse energy less than 1 W and 1 nJ. Also, multi-stage setup makes the THz source complicated and significantly increases its cost especially when expensive Ti: Sapphire tunable laser is used in the system.

### THz Sources in the State of the Art

Hereinafter, currently existing THz sources are briefly described. They are subdivided into pulsed and continuous wave sources. The performance which can typically be achieved with these sources and their current price are indicated respectively.

### Pulsed THz Sources:

### Photo-Conductive Dipole Antenna

A big step for THz technology was the appearance of mode-coupled titanium-sapphire lasers which emit pulses lasting only a few tens of femtoseconds. Since then numerous methods have been demonstrated which are suitable for generating and detecting THz pulses based on a femtosecond laser. The oldest and probably most widespread method is based on photoconductive antennas which are excited by femtosecond pulses. These antennas consist of a piece of gallium arsenide onto which two parallel metal stripe conductors have been vapor deposited. The laser pulses generate charge carriers between the conductors which are accelerated through an applied electrical field. The consequence is a short current pulse which represents the source of a THz pulse emitted into the space.

If an unamplified titanium-sapphire laser is used for the excitation, the CW power lies in the range of microwatts. The price level is prevailingly determined by the femtosecond laser and currently lies at 50,000 [symbol] .

### Synchrotron, Free-Electron Lasers and Smith-Purcell Emitter

A less compact class of THz emitters, based on an electron beam, comprises synchrotron, free-electron lasers, so called Smith-Purcell emitters and backward-wave tubes. In a synchrotron and in a free-electron laser, electrons are sent through a region with alternating magnetic fields in which they oscillate from one side to the other. This oscillating electron movement leads to the emission of THz radiation. The Smith-Purcell emitter is based on an electron microscope whose electron beam propagates along the surface of a metallic lattice. This very expensive class of sources has to be discarded for practical applications due to its considerable size.

### Backward-Wave Tube

Backward-wave tubes, also called carcinotrons, are approximately the size of a football. In these electrovacuum devices, electrons fly over a comb-like structure, which combines them in periodic bundles, leading to the emission of THz radiation. Although they are not modern devices, backward-wave tubes are high-power sources, which are able to generate 10 mW of monochromatic, but tunable THz power at several 100 GHz. The emitted performance declines with the frequency and the tuning range of a carcinogen amounts to approximately 100 GHz. At present, they are only produced in Russia and cost approx. 25,000 [symbol] and more.

### P-Germanium Laser

P-germanium lasers use transitions of holes from the light to the heavy hole band and deliver strong THz pulses: Until now, the p-germanium laser only worked, however, at low temperatures and in pulsed operation. Furthermore, it requires a magnetic field. This makes it unsuitable for applications outside of the laboratory. The costs lie in the range of 200,000 [symbol] .

### Quantum Cascade Laser

The quantum cascade laser (QCL) is a very promising technology for the realization of compact sources working at room temperature, monolithically, run with current, for the range from 1-5 THz. QCL were presented for the first time in 1994 by Faist and colleagues. Early QCL still required cryogenic cooling, worked only in pulsed operation, and emitted in the middle infrared range. Considerable progress has been made since the first beginnings Development went to continuous wave, higher temperatures and bigger wavelengths. Nowadays, QCL, which are run in the middle infrared range, run in cw mode and at temperatures, which exceed even room temperature. These QCL are suitable for industrial applications.

Until the late nineties, it was assumed that the working frequency could never been brought under 5 THz. In 2002, however, Tredicucci and colleagues presented a QCL which worked at 4.4 THz. In 2004, a QCL was presented, which emitted continuous radiation at 3.2 THz up to a temperature of 93 K. The cw output power at 10K amounted hereby to 1.8 mW. The output power in pulsed operation of THz QCLs is always higher, namely in the range of many mW. Furthermore, pulsed THz QCLs work at higher temperatures, but still require cooling.

In 2006, another group demonstrated a QCL for a frequency of 2 THz, which allowed for a cw mode at 47 K and had a maximum power of 15 mW at T=4K. In the year 2007, a third group achieved a cw power of 24 mW at 20K and a frequency of 2.8 THz. As a result of this, light, portable THz sources are able to be produced with the help of Stirling coolers with closed cycle. THz QCLs based sources cost between 50,000 and 100,000 [symbol] .

### Continuous Wave THz Sources:

### THz Gas Laser

Molecular gas lasers, also referred to as FIR lasers, are based on transitions between different rotational states of a molecular species. Hereby, they are suitable for emitting an output in the tens of mW range at discrete THz frequencies. The discrete operating frequencies range from less than 300 GHz to more than 10 THz. The most intensive methanol line is obtained at 2.52 THz. Such a laser has to be pumped, however, by a tunable carbon dioxide laser. This implies a big space requirement for the entire system. Unfortunately, THz gas lasers are not only bulky, but also expensive (almost 100,000 [symbol] ).

### Quantum Cascade Laser

Quantum cascade lasers have already been discussed above as a pulsed THz source. They also run in cw mode, but with lower power, which has also been discussed above.

### Emitters Based on Classical Microwave Technique

THz emitters are suitable for being realized with the help of microwave technology based on Gunn, Impatt or resonant tunnel diodes. As the fundamental frequencies of these systems are in most cases not high enough for many THz applications, they have to be multiplied first by specific mixers. A THz source based on microwave technology fits easily in a shoe box. Typically, they cost several tens of thousands of euros. The power at frequencies above one THz is under 1 mW and the sources are only partly tunable. The tunability lies in the range of few tens of GHz.

### Photomixer

A widely spread method for the generation of THz radiation is based on photoconductive THz antennas which are excited optically by two cw laser diodes oscillating with slightly different frequency. The emission of these lasers is superposed on the antenna, which is also referred to as Photomixer when excited with cw lasers. The resulting beat of light is hereby converted into an oscillating antenna current which is the source of a monochromatic THz wave. The achieved power lies at a few μW. Including the pump lasers, a THz source costs 10,000 to 20,000 [symbol] .

### Direct Radiation of Two-Color Lasers

Recently, Hoffmann and colleagues (University of Bochum) were able to show that two-color lasers emit even THz radiation due to a nonlinear process. However, the radiation power was very low and was located at the detection limit. The price lies at a few 1,000 [symbol] .

The following table summarizes the data of the available cw THz systems, and includes for comparison data for an exemplary device of the present invention in the last row. Amongst others, the power P_max in the area of 1 THz, the tunability, the system size and costs are listed.

TABLE 1

| | | P_max | | System | Price (in | |
|---|---|---|---|---|---|---|
| Method | CW | (mW) | Tunability | size | thousand $) | Remarks |
| Gas laser | X | up to | discrete | big | 100 | strongest line at 2.5 THz |
| | | 50 | lines | | | (50 mW), other lines |
| | | | | | | only emit few mW |
| Microwave | X | <1 | Hardly | shoe | 60 | Power decreases above |
| Based | | | | box | | 1 THz |
| Photomixing | X | 0.005 | Yes | small | 15 | Power decreases above |
| | | | | | | 1 THz |
| THz QCL | X | 30 | hardly | small | 50 | Requires cooling, power |
| | | | | | | improves yearly |

In summary, it has to be noted that many different THz sources exist, each with its own advantages and problems.

The disadvantages often consist in the fact that the systems are very complex and, thus, expensive or/and relatively under-performing (power in the range of only μW) or/and are not tunable or/and are only suitable to be run in pulsed operation or even have to be cooled in a complex manner.

### Development and Demonstration of High-Power High-Brightness VECSELs

Optically pumped semiconductor vertical-external-cavity surface-emitting lasers (VECSELs) are particularly attractive for their high power and excellent beam quality. VECSELs combine the techniques of diode-pumped solid state thin disk lasers and semiconductor quantum-well vertical-cavity surface-emitting lasers. In these lasers, a semiconductor multi-quantum wells active region and a distributed Bragg reflector (DBR) stack, only a few microns thick, is mounted on the heat spreader or heat sink, resulting in efficient heat dissipation which makes VECSEL a strong candidate in power-scalable lasers. Optical pumping of multi-quantum wells is the most straightforward way to achieve a uniform carrier distribution over a large pump area, and is particularly advantageous for multi-watt operation. The external output coupler (mirror) controls transverse mode operation.

The VECSELs are fabricated using multiple quantum wells where each well is placed at the antinode of the cavity standing wave to achieve the maximum relative confinement factor and modal gain. The position of the antinodes of the cavity standing wave is then controlled by the optical thickness of the microcavity. High-power CW operation of VECSEL requires high-gain multi-quantum well (MQW) structures combined with efficient heat extraction from the active region. Based on the microscopic many-body theory, the VECSEL structure is designed. To delay the thermal rollover, the active region is designed so that the quantum-well gain peak is blue-shift initially with respect to the microcavity resonance, to account for a higher rate of thermally induced shift of the gain peak, compared to the rate of shift of the microcavity resonance, FIG. 2A-2C. The schematic VECSEL setup 200 includes a heat sink 202, distributed Bragg reflector 204, quantum wells 206, and curved dielectric output coupler 208 arranged as shown in FIG. 2A.

To develop high-power high-brightness 975-nm VECSEL, two VECSEL structures have been designed. Structure I comprises a Single-Well resonant Periodic Gain (SW-RPG). The active region consists of 14 InGaAs compressive strained quantum wells. Each quantum well is surrounded by GaAsP strain compensation layers and AlGaAs pump-absorbing barriers. The thickness and composition of the layers are optimized such that each quantum well is positioned at an antinode of the cavity standing wave to provide resonant periodic gain (RPG). Structure II comprises a Double-Well Resonant Periodic Gain (DW-RPG). The active region consists of nine double-wells each comprised of two compressive strained InGaAs quantum wells separated by GaAsP strain compensating layer. The thickness and compositions of the layers are optimized such that each double-well is positioned at an antinode of the cavity standing wave to provide resonant periodic gain in active region. A high reflectivity (R>99.9%) DBR stack is grown on the top of the active region.

The epitaxial side of the VECSEL wafer is then mounted on CVD diamond by indium solder. After the removal of the GaAs substrate, a single layer Si₃N₄ quarter wave LR coating is deposited on the surface of VECSEL chip to achieve a reflectivity less than 1% at the signal wavelength. The VECSELs with an output power in excess of 10-W with a good beam quality (M²<1.75) and a slope efficiency of 44% are demonstrated. The circulating power inside the cavity can reach over 200 W using a low transmittance output coupler of about 5%. This can be significantly higher if the high-Q cavity is employed. The coherent power scaling of VECSEL was investigated recently. Experimental results show that the output power is even doubled when two VECSEL chips are employed in a desired zigzag folded cavity.

Spectral Control of High-Power VECSELs (Tunable VECSEL with Narrow Linewidth)

While optically pumped semiconductor vertical-external-cavity surface-emitting lasers (VECSEL) have shown great potential as compact high power sources, their wavelength stability is typically poor. In fact due to thermally induced wavelength shift, the lasing wavelength red-shifts with the increase of pump power. Also, due to the growth variation, the wavelength of VECSEL can be slightly off from the designed lasing wavelength.

A tunable high-power high-brightness VECSEL with a narrow linewidth and stable operation is a desired candidate to overcome these drawbacks and to control the spectra of the VECSEL. To achieve a tunable high power VECSEL with a wide tuning range, we have deployed a V-shaped cavity in conjunction with a birefringent filter (BF) shown in FIGS. 3A-3B. As shown, the experimental setup 300 includes a heat sink 302, a VECSEL chip 305, a HR flat mirror 312, a birefringent filter 310, an output coupler 308, a distributed Bragg reflector 304, multiple quantum wells 306, and an LR coating 318. In this cavity, the VECSEL chip (active mirror) is placed at the fold, a high reflectivity (R>99.9%) flat mirror and a spherical output coupler on the two ends. Since the lasing eigenmode (signal beam) of the V-shaped cavity is incident to the VECSEL chip with a small incident angle, the propagation direction of the signal beam in the semiconductor microcavity, formed by DBR and semiconductor/air interface, is not perpendicular to the surface of the VECSEL chip and DBR mirror. As a result, the cavity eigenmode no longer experiences the microcavity resonance, which influences the lasing wavelength. A birefringent filter is inserted in the V-shaped cavity to tune the modal gain spectrum of the VECSEL to achieve wide tunability.

To eliminate the etalon resonance and walk-off losses in the tilted intracavity etalon, a low reflectivity coating is applied on the surface of the VECSEL chip. In a round trip, the cavity mode passes through the active region four times in the V-shaped cavity and two times in the linear cavity, thus the V-shaped cavity, in which VECSEL chip serves as a folding mirror, provides higher round trip gain for a given carrier density and temperature than the other cavities in which the VECSEL chip works as an end mirror. This higher round trip gain not only compensates walk-off losses and surface scattering loss, but also enlarges the tunability.

To achieve tuning, the birefringent filter (BF) is inserted in one arm of the V-shaped cavity at Brewster's angle. The transmission of the BF is equal to 1 at

$$ϕ = \frac{2 π}{λ} [ {n}_{e} ( {θ}^{′} ) cos {θ}_{e} - {n}_{o} cos {θ}_{o} ] d = 2 m π with m = integer ,$$

where nₒ and nₑ(θ′) are refractive indices for ordinary and extraordinary ray, λ is vacuum wavelength and d is the plate thickness along the beam direction within the plate. The laser signal beam at the wavelength λ, in the cavity suffers no loss passing through the plate. Rotating the BF about its surface normal changes nₑ(θ′), thus tunes the wavelength to the maximum transmission of the filter (T=1). Since the cavity mode no longer experiences the microcavity, by rotating the BF, we can tune across the modal gain spectrum (proportional to Γᵣ(λ)g(λ)), where Γᵣ(λ) is the relative confinement factor and g(λ) is quantum well gain spectrum, and achieve a large continuous wavelength tuning range.

FIGS. 4A-4D show the performance of the tunable VECSEL using the DW-RPG structure. The output power is reduced only slightly by the insertion of the birefringent filter, but the spectral purity is improved significantly. The traces in FIG. 4B show several orientations of the birefringent filter; they are not simultaneous. By rotating the filter around the normal to its surface, we continuously tune the lasing wavelength over 20 nm, FIG. 4C. In FIG. 4C, the calculated quantum well gain spectrum is shown as a solid line. The stability of the wavelength tuning is shown in FIG. 4D, where all traces are taken at a fixed of pump power and a heat sink temperature of 10° C. The work was highlighted in the March 2006 issue of Photonics Spectra, section Photonics Technology News.

### Intracavity SHG in a VECSEL Cavity

The linear polarization of the VECSEL beam is very important for intracavity nonlinear frequency conversion. Based on this high-power high-brightness linearly polarized VECSEL and intracavity frequency doubling, the generation of tunable watt-level blue-green (around 488 nm) coherent emission has been demonstrated. In the experiment, a LBO crystal and type I phase matching are used. FIGS. 5A-5B show the experimental setup 500 and the fundamental and SHG spectra. As shown, the experimental setup 500 includes a heat sink 502, a VECSEL chip 503, a HR flat mirror 508, a birefringent filter 504 at the Brewster angle, an output coupler 512, low pass filter 514, and LBO crystal 510. Despite non-optimized cavity mirrors, over 1.3 watts of second-harmonic output at 488 nm has been measured. This work was highlighted in Photonics Spectra September 2006.

### Multi-Chip VECSEL

To achieve higher power and larger tunability, a multi-chip VECSEL as a coherent power scaling scheme has been demonstrated. Since the gain spectrum of the multi-chip VECSEL is the superposition of the gain spectrum of each chip, a multi-chip VECSEL easily achieves a higher and broader gain spectrum than a single chip VECSEL does, resulting in the potential of a larger tunability with high output power. In addition, the quantum well gain spectrum is sensitive to its structure, carrier density and temperature. Multi-chip VECSEL provides flexibility to control its modal gain spectrum by changing the pump or temperature on each chip, manipulating the tuning curve (output power vs. wavelength) of the laser such that the laser provides a larger tuning range and less variation of output power with wavelength. FIG. 6 shows that the two-chip VECSEL is an efficient coherent power scaling scheme.

### SUMMARY OF THE DISCLOSURE

In one of its aspects, the present invention may provide a multi-wavelength vertical external cavity surface emitting laser. The laser includes a vertical external cavity surface emitting laser chip having an active region comprising a plurality of semiconductor quantum wells having an inhomogeneous broadened gain. An external cavity is included in optical communication with the laser chip to receive optical radiation emitted by the laser chip and configured to support lasing. In addition, a wavelength selective filter is disposed within the cavity, and the wavelength selective filter is configured to provide a laser output that oscillates at two or more separated wavelengths simultaneously.

In another of its aspects, the present invention may provide a method for creating simultaneous lasing at two or more separated wavelengths within a vertical external cavity surface emitting laser. The method includes providing a vertical external cavity surface emitting laser chip having an active region comprising a plurality of semiconductor quantum wells having an inhomogeneous broadened gain. In addition, an external cavity is provided in optical communication with the laser chip to receive optical radiation emitted by the laser chip and configured to support lasing. The method also includes providing a wavelength selective filter configured to provide a laser output that oscillates at two or more separated wavelengths simultaneously. Additionally, the method includes orienting the wavelength selective filter within the cavity at an angle to create the output that oscillates at two or more separated wavelengths simultaneously.

In yet another of its aspects, the present invention may provide generation of terahertz (THz-) waves or millimeter waves by means of a non-linear medium positioned within the laser resonator of a Vertical Cavity Surface Emitting Laser (VECSEL) or of another laser (wherein the other laser is preferably a disc laser, for example) through difference-frequency generation. This THz-radiation is guided and extracted by means of THz optics which has been optimized for that purpose. The laser medium and the laser design are conceived in such a way that the highest possible THz generation and extraction are possible. Hereby, the optimal VECSEL laser medium is determined by a high amplification performance (a high gain), high spectral bandwidth and suitable spectral position in such a way that pump lasers, which are as economic and/or as powerful as possible, or other pump sources are suitable for being used.

A prototype has already been designed and THz performance emission has been verified in continuous-wave operation at room temperature. The corresponding device according to the present invention and the method are, however, also suitable for being used in pulsed mode operation. The presented practical embodiments allow expectations of THz performances of many milliwatts, possibly up to the watt-level range.

In one of its aspects, it is thus one aim of the invention to provide a device, including the singular components required therefore, as well as a method for the generation of terahertz or millimeter waves, which avoid(s) the aforementioned disadvantages as much as possible. These aims may be achieved by providing a device for the generation of electromagnetic radiation in the terahertz and millimeter range, in which the device comprises: a) a laser resonator with laser light source integrated therein in the form of at least one VECSEL or at least one further laser light source, such as a disc laser; b) a nonlinear medium, wherein the medium is realized for difference-frequency generation in the terahertz or millimeter range and arranged within the laser resonator; and, c) extraction optics for the extraction of electromagnetic radiation in the terahertz and millimeter range out of the laser resonator, wherein these are arranged either inside or outside the resonator. The nonlinear medium and the extraction optics may be arranged jointly in the form of a nonlinear crystal. The nonlinear crystal may include an outcoupling structure in order to avoid reflection losses at the boundary layer between crystal and air, and the outcoupling structure may comprise, for example, an obliquely cut crystal edge, a superimposed, obliquely cut coating, or a superimposed prism or a prism-like surface structuring of the crystal. In addition, if a VECSEL is used, the device may include an optical or electrical pump for pumping the VECSEL.

A method of the invention may include a generation of electromagnetic radiation in the terahertz and millimeter range by the steps of providing a nonlinear medium; positioning of this medium within a laser resonator of a VECSEL or another laser, such as a disc laser; and operating the laser in two-color or multi-color operation in such a way that terahertz (THz) radiation is generated through difference-frequency generation inside the cavity. The method to extract the THz generated radiation may include providing a suitable THz optics which has been optimized for that purpose, wherein this optics is characterized by the fact that it suitably separates the THz radiation from the optical waves. Suitable separation may take place inside or outside of the resonator, and may take place by means of a filter element which absorbs the THz radiation and the optical radiation at different strengths and/or reflects at different strengths and/or reflects at different angles and/or bends at different angles. The filter element may be realized through a suitable substrate which is transparent for the optical wave and is suitably coated with indium tin oxide (ITO) or with a dielectric THz mirror or with another suitable optically transparent material, so this element reflects the THz radiation and lets the optical wave pass. In addition, the filter element may be realized through a material which comprises a high refraction index in the THz range and, thus, a high reflectivity, but is only slightly reflective for the optical wave. Still further, the filter element may be realized through a suitable substrate which is transparent for the THz wave and is suitably coated with a dielectric mirror for the optical wave or with another suitable material which is transparent in the THz range, where this element reflects the optical radiation and lets the THz wave pass. Yet further, the filter element may be: (i) realized through a material which comprises a high reflectivity in the optical range, but is only slightly reflective for the THz wave; (ii) realized through an optical lattice, which bends the THz radiation in a direction than that of the optical radiation; (iii) realized through a polymer or coated glass or semiconductor material which is transparent for the THz radiation and absorbs the optical wave; (iv) used within the cavity as an etalon; (v) coated with an anti-reflective coating for the optical wavelengths; and/or (vi) coated with an anti-reflective coating for the THz wavelengths. In addition, the separation of the THz radiation from the optical waves may take place by means of a crystal, which does not emit the THz radiation collinearly to the optical wave or by means of laser mirrors, which are transparent for the THz waves, but opaque for the optical wave.

The THz extraction optics may minimize the reflection losses of the THz radiation, e.g., through: a suitable THz-anti-reflective coating of the optical components; use of the Brewster angle; use of suitable, slightly reflective materials; and/or outcoupling structures which suitably adjust the THz radiation generated within the crystal to the environment in order to avoid total reflection.

The THz extraction optics may also collect the THz radiation and shape it, where these elements may comprise, for example, THz lenses and/or THz mirrors, e.g., spherical, aspherical, cylindrical, Fresnel, and/or GRIN lenses as well as parabolic, spherical and/or elliptical mirrors. The THz extraction optics may thus collect and image as much as possible of the generated radiation, minimize the imaging error, and cause as little loss as possible through absorption, reflection, and/or scattering.

The materials and structures used with exemplary devices and methods of the present invention may be configured to yield a gain spectrum that provides: as high an amplification as possible for a given charge carriers' density (for high THz output power); as large of spectral bandwidth as possible (for tunability of the generated THz radiation); and/or, an optimized spectral position in relation to available pump lasers (use of cheap and/or powerful commercial pump sources). The power density available within the nonlinear crystal may desirably be maximized by: placing the crystal where the laser beam has its smallest diameter within the resonator (in the actual demonstrator: directly in front of the planar, highly reflective mirror); positioning one further concave, highly reflective mirror outside the resonator in the laser beam and reflecting the beam exactly to the active medium, where the additional mirror is coupled with the resonator and the optical intensity within the resonator is considerably increased; replacing a partly transparent output coupler by a highly reflective mirror with shorter, identical or longer focal length, where the power density within the resonator is able to be significantly increased; focusing the laser irradiation within the resonator to the area of the crystal by means of lenses; and/or running two separate VECSEL in a joint resonator, wherein one of both or both are suitable for being modified in their laser wavelength and, thus, for generating a significantly higher intracavity intensity than one individual VECSEL.

Phase matching may be achieved exemplary devices and methods of the present invention. Phase matching may be characterized in the fact that: it is achieved for an embodiment of a THz source which is tunable over a wide spectral range; or it is optimized for an embodiment of a THz source with a fixed frequency; or it is able to be achieved through the use of suitable nonlinear crystals (due to their material parameter); it is able to be achieved in particular through the use of suitable birefringent nonlinear crystals; or it is able to be achieved through a suitable quasi-phase-matching (QPM) (through the polarity of the ferroelectric domains in the crystal). This polarity is able to comprise, in particular, a tilted/untilted periodic polarity, a tilted/untilted aperiodic polarity, a chessboard-shaped polarity, a fan-out polarity or a combination thereof.

In addition, the materials and structures used with exemplary devices and methods of the present invention may be configured to have a suitable waveguide structure with nonlinear elements. Within this waveguide structure, a guidance of the waves is able to take place characterized by the fact that: either only the optical waves or only the THz waves or both of them are able to be guided; the effective group velocities or the effective refraction indices of the waves are adjusted; an as big as possible overlapping is achieved between the optical wave and nonlinear material; an as small as possible mode radius of the optical wave within the nonlinear material is obtained; it is able to be achieved, in particular, with a structured or unstructured nonlinear crystal or a combination of one or several structured or unstructured nonlinear media and other structured or unstructured materials; it is able to be achieved, in particular, through strip waveguides, flushly embedded strip waveguides, buried strip waveguides, ridge waveguides, inverted ridge waveguides, dielectric slab waveguides, metal slab waveguides; and/or it is able to be achieved, in particular, through photonic crystal structures.

The THz radiation may be emitted in a suitable direction, i.e. collinear or under a suitable angle, wherein this is able to be adjusted, for example, through the selection of the crystal material or the QPM.

Suitable materials that may be used with exemplary devices and methods of the present invention include materials which: comprise a nonlinear coefficient of second or higher order; comprise as high a nonlinear coefficient as possible; comprise as little an absorption coefficient as possible; comprise as high a damage threshold as possible; are suitable for being doped in order to increase the damage threshold and/or the nonlinear coefficient and/or to decrease the absorption. Exemplary materials include the following substances:

Lithium niobate (LiNbO₃) in congruent and stoichiometric form. This material is suitable for being provided with a QPM particularly efficiently. In particular, periodically poled lithium niobate (PPLN), tilted periodically poled lithium niobate (TPPLN), aperiodically poled lithium niobate (APPLN), tilted aperiodically poled lithium niobate (TAPPLN), chessboard-shaped poled lithium niobate and lithium niobate with a fan-out polarity are suitable. Another embodiment is an unstructured bulk lithium niobate crystal, which is provided with an outcoupling structure, in order to use THz irradiation under the Cherenkov angle. In order to reduce the photorefractive effect, these embodiments are suitable for being doped with other substances, for example with magnesium oxide (MgO) or manganese (Mn);

GaAs; zinc germanium diphosphide (ZGP, ZnGeP₂), silver gallium sulfide and selenide (AgGaS₂ and AgGaSe₂), and cadmium selenide (CdSe); ZnSe; GaP; GaSe; lithium tantalate (LiTaO₃); Lithium triborate; potassium niobate (KNbO₃); potassium titanyl phosphates (KTP, KTiOPO₄);

all materials from the “KTP family” and also KTA (KTiOAsO₄), RTP (RbTiOPO₄) and RTA (RbTiAsPO₄), are likewise suitable for being periodically poled

potassium dihydrogen phosphate (KDP, KH₂PO₄) and potassium dideuterium phosphate (KD*P, KD₂PO₄)

beta barium borate (beta-BaB₂O₄=BBO, BiB₃O₆=BIBO, and cesium borate (CSB₃O5=CBO), lithium triborate (LiB₃O5=LBO), cesium lithium borate (CLBO, CsLiB₆O10), strontium beryllium borate (Sr₂Be₂B₂O₇=SBBO), yttrium calcium oxyborate (YCOB) and K₂Al₂B₂O₇=KAB

organic nonlinear media, in particular DAST

nonlinear media on a polymer basis, for example electro-optical polymers, in particular, all compounds which comprise amorphic polycarbonates or phenyltetraenes,

silicon or strained silicon or furthermore, all semiconductor materials, in strained or unstrained form, which comprise a non-disappearing, nonlinear x-coefficient.

Nonlinear medium for the conversion of IR radiation into terahertz waves in exemplary devices and methods of the present invention, may be provided in the form of a periodically poled lithium niobate (TPPLN), which comprises a tilted structure in relation to the crystal surface and, thus, also a periodical polarity in the direction of the emitted THz waves in such a way that destructive interference of the formed THz waves is compensated, and the IR beam diameter is able to be chosen significantly larger without any reduction of the conversion efficiency.

Surprisingly it has been found that different nonlinear media are suitable for being used in an intracavity manner in order to generate terahertz and millimeter waves, as they do not only resist the impinging power densities, but also ensure an efficient generation of frequency difference. This applies for continuous wave mode as well as for pulsed mode and also for spectral tunability of the entire device.

A summary of the power data of existing THz sources (FIG. 13) shows clearly the so called THz gap. In the range between few hundreds of GHz and several THz, no compact tunable sources exist at present. Our powerful “new THz source,” which is described in the following, is suitable for filling this gap. The power data indicated for the new source represent a conservative estimation. With some of the practical embodiments stated in the following, THz power or/and the power in the range of millimeter waves are considerably higher is expected.

### BRIEF DESCRIPTION OF THE DRAWINGS

The foregoing summary and the following detailed description of the preferred embodiments of the present invention will be best understood when read in conjunction with the appended drawings, in which:

FIG. 1 illustrates the electromagnetic spectrum, showing that basic research, new initiatives and advanced technology developments in the THz band are limited and remain relatively unexplored;

FIGS. 2A-2C schematically illustrate a VECSEL setup active MQW layer structure (FIG. 2A) and corresponding standing wave (FIGS. 2B-2C), respectively;

FIGS. 3A-3B schematically illustrate an experimental setup of a tunable VECSEL with a V-shaped cavity;

FIGS. 4A-4B illustrate that the output power is reduced only slightly by the insertion of the birefringent filter (A), but the spectral purity is improved significantly (B), with the traces in (B) showing several orientations of the birefringent filter (they are not simultaneous);

FIGS. 4C-4D illustrate that by rotating the filter around the normal to its surface, the laser is continuously tuned across its ˜20-nm gain bandwidth (C), with the stability of the wavelength tuning is shown in (D), where all traces is taken at 24 W of pump power and a heat sink temperature of 10° C.;

FIGS. 5A-5B schematically illustrate an experimental setup of intracavity SHG with a tunable VECSEL and spectra of the fundamental beam (˜976 nm) and SHG (˜488 nm), respectively;

FIG. 6A illustrates experimental results of a two-chip VECSEL showing a comparison of the performance of single chip and two-chip VECSELs;

FIG. 6B schematically illustrates beam quality factor as a function of output power and 3D beam profiles;

FIGS. 7A-7C illustrate lasing spectra without/with a tilted FP etalon (dashed/solid line) at 16.4-W pump (7A) and 26.5-W pump (7B and 7C);

FIG. 8 illustrates spectra of extracavity sum frequency generation (SFG) of dual-wavelengths of the VECSEL and second harmonic generation (SHG) of each fundamental wavelength;

FIGS. 9A-9B schematically illustrate a diagram of the collinear phase-matched THz DFG in a dual wavelength VECSEL;

FIGS. 10A-10B illustrate forward and backward configurations in terms of wave vectors kₚ, kₚ, kₚ for the pump, signal (THz) and idler waves, respectively;

FIG. 11A-11B schematically illustrates diagrams of collinear phase-matched THz DFG inside or outside dual-wavelength VECSEL;

FIG. 12 schematically illustrates a linearly polarized dual-wavelength VECSEL with a V-shaped cavity, a Brewster window, and an intracavity tilted FP etalon;

FIG. 13 illustrates power data of existing THz sources along with power data expected from devices according to the present invention (“new source”), which promises a power improvement of several orders of magnitude as compared to systems which are already available;

FIG. 14 schematically illustrates an example of a waveguide in which different materials were used;

FIG. 15 schematically illustrates the polarity structure of a surface-emitting PPLN;

FIG. 16A schematically illustrates the periodic polarity of a TPPLN which is tilted at an angle of α;

FIG. 16B schematically illustrates the periodic polarity of chessboard crystal type with 2D polarity;

FIGS. 17A and 17B illustrate VECSEL spectrum in two color and many color operation, where the wavelength, as well as the frequency distance of the line, is able to be modified through tilting the etalon;

FIG. 17C schematically illustrates a current exemplary design of a device in accordance with the present invention for intracavity THz generation with a nonlinear crystal;

FIGS. 18A-E illustrate emitted THz output power (arbitrary units) of the TPPLN and the number of the oscillating laser lines at different output powers;

FIG. 19 illustrates THz output power (arbitrary units) emitted from the TPPLN bundled with an improved THz optics and detected with a Golay cell;

FIG. 20 illustrates THz output power (arbitrary units) at f=675 GHz and optimized resonator configuration;

FIG. 21A illustrates different semiconductor materials and wavelengths;

FIG. 21B illustrates lattice constants and band gap energies of several semiconductors;

FIG. 22 schematically illustrates an exemplary design of a device in accordance with the present invention having a two-color VECSEL with optical elements in the resonator;

FIG. 23 schematically illustrates an exemplary design of a device in accordance with the present invention having laser radiation of the VECSEL overlapped by one of an external laser in a nonlinear material found in the VECSEL resonator;

FIG. 24 schematically illustrates an exemplary design of a device in accordance with the present invention having two VECSELS in a joint resonator;

FIG. 25 schematically illustrates an exemplary design of a device in accordance with the present invention having two VECSELs with separated resonators, with the nonlinear material found at the intersection of both laser resonators;

FIG. 26A schematically illustrates an exemplary design of a device in accordance with the present invention having the laser radiation of two VECSELS overlapped outside the cavity and directed over one or several nonlinear materials which are found in a further external resonator;

FIG. 26B schematically illustrates an exemplary expanded, current design of a device in accordance with the present invention having design for intracavity THz generation with a nonlinear crystal and additional highly reflective (R>99%), concave mirror, which reflects the decoupled power back exactly in the resonator;

FIGS. 27A-D schematically illustrate different possibilities of separating the THz radiation from the optical radiation, where FIG. 27A schematically illustrates collinear THz generation with an external filter, FIG. 27B schematically illustrates collinear THz generation with a resonator-internal THz mirror, FIG. 27C schematically illustrates a collinear THz generation with a resonator-internal mirror for the optical wave, and FIG. 27D schematically illustrates an alternative where a surface-emitting crystal is suitable for serving as the source of the THz radiation;

FIG. 28A schematically illustrates total reflection which can occur at the boundary layer between the crystal and the air;

FIG. 28B schematically illustrates a outcoupling structure is suitable for avoiding total reflection; and

FIGS. 29A-F schematically illustrate examples of quasi phase matching (QPM) possibilities in non-linear crystals, where FIG. 29A illustrates simple periodic polarity, FIG. 29B illustrates tilted periodic polarity, FIG. 29C illustrates chessboard-shaped polarity, FIG. 29D illustrates simple aperiodic polarity, FIG. 29E illustrates tilted aperiodic polarity, and FIG. 29F illustrates fan-out polarity.

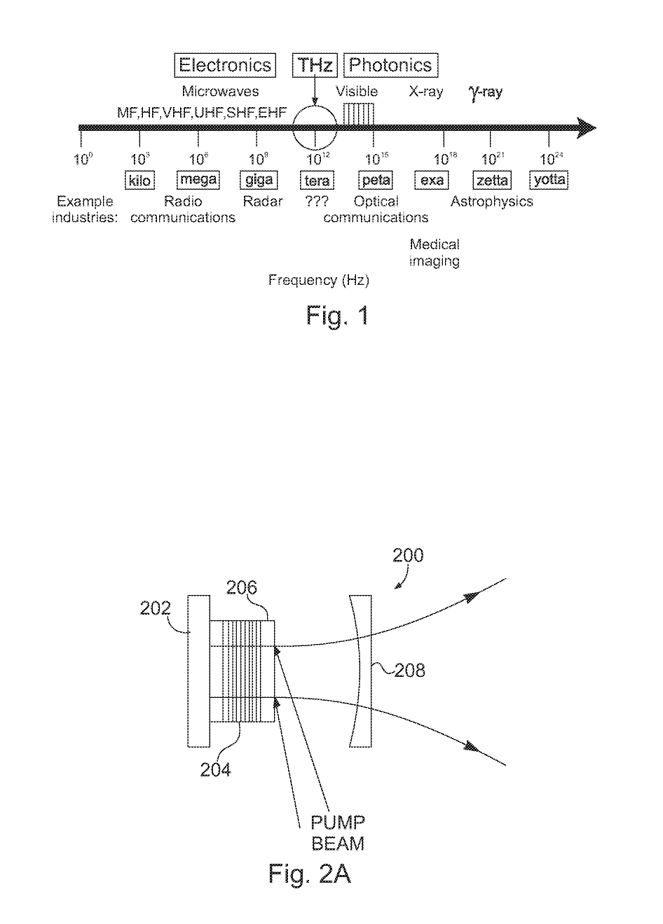

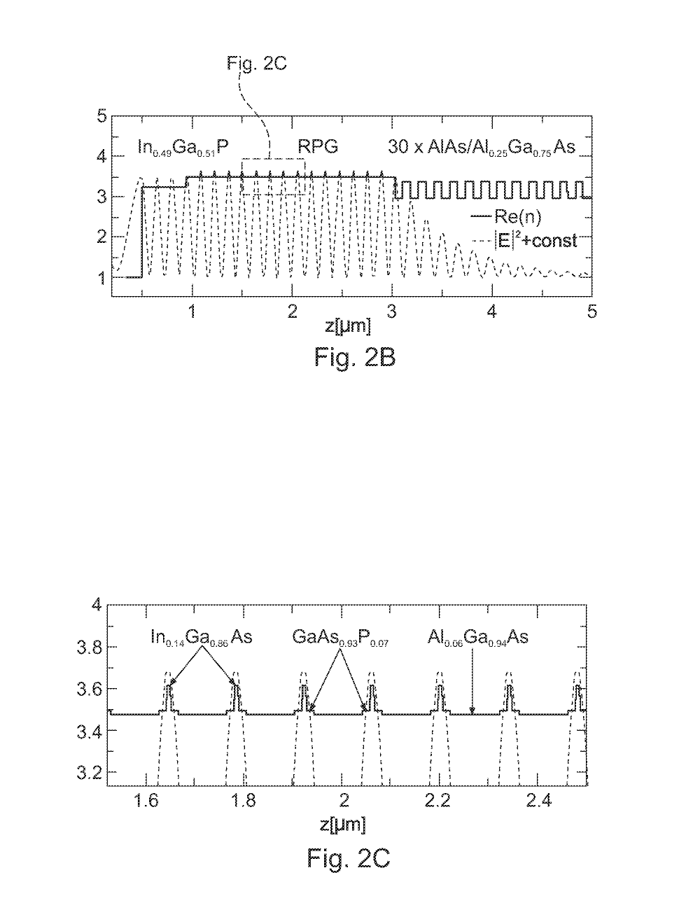

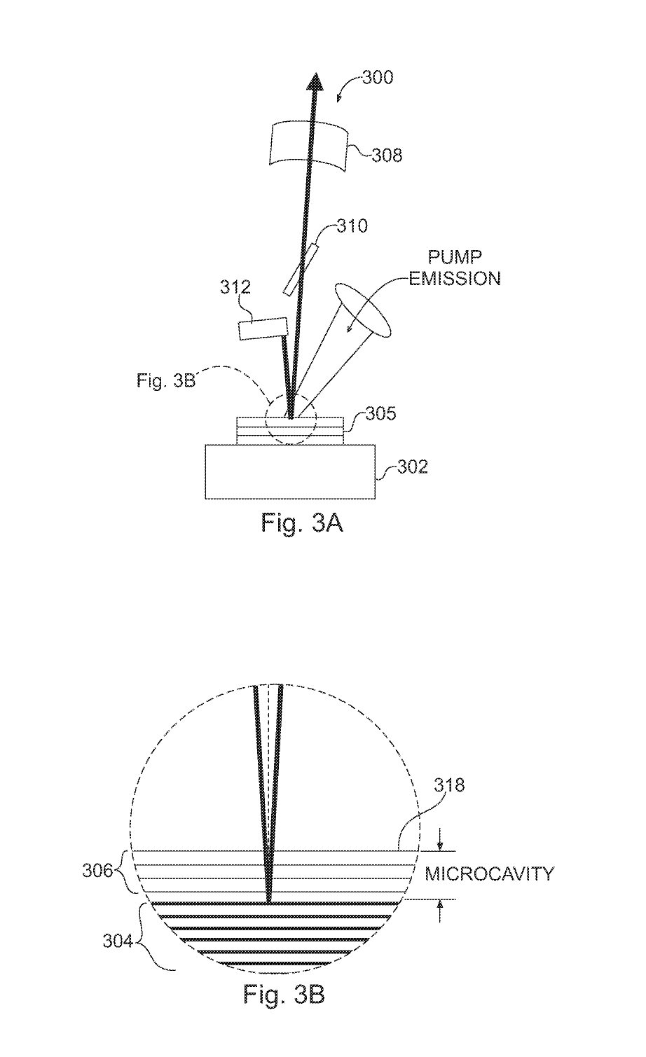

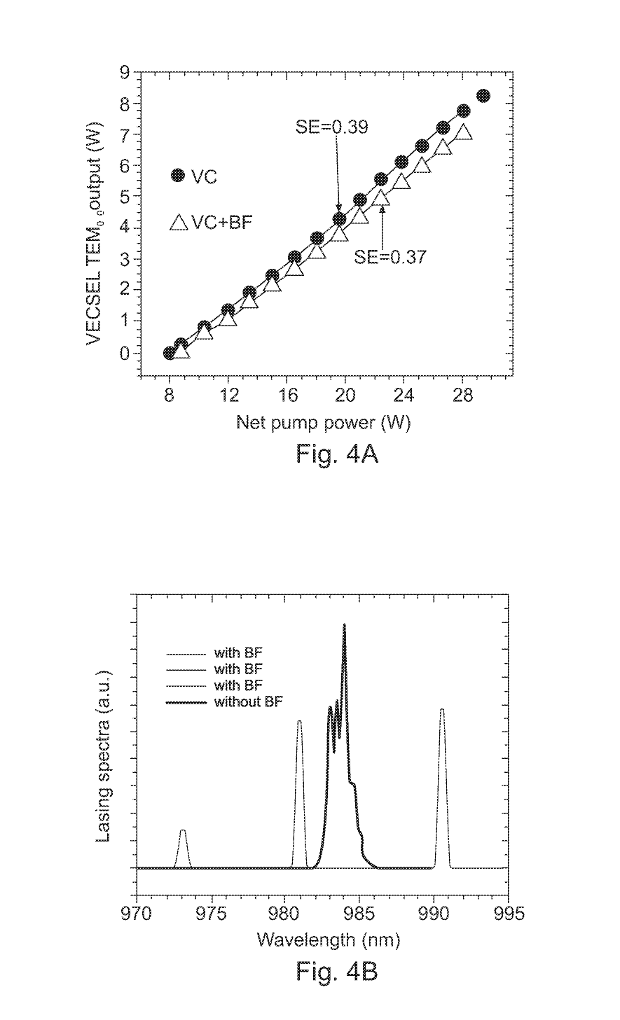

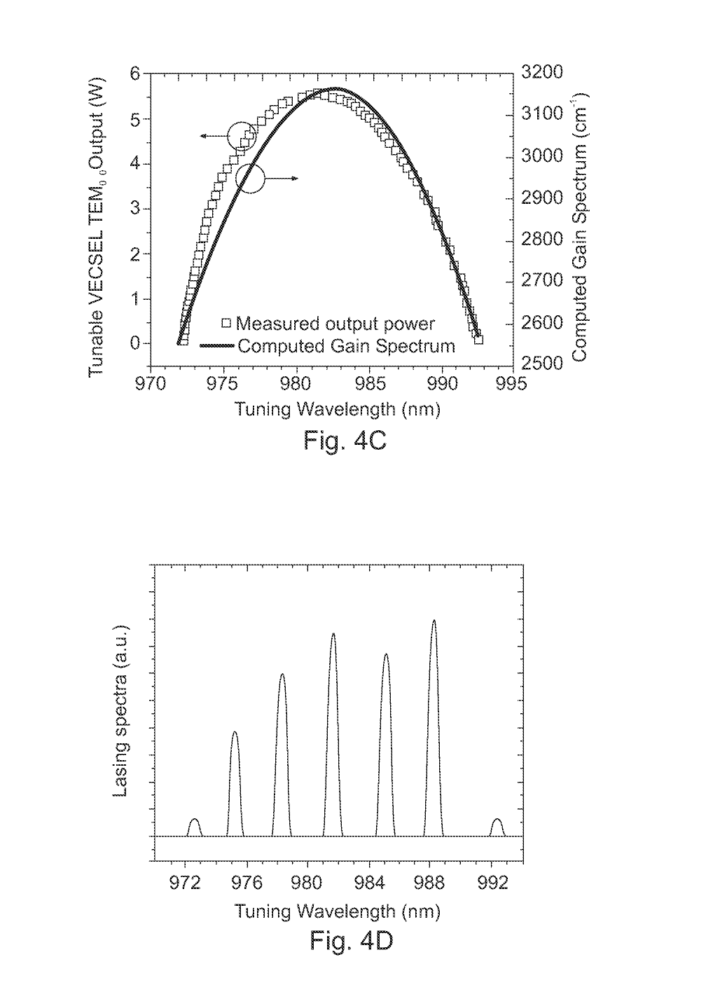

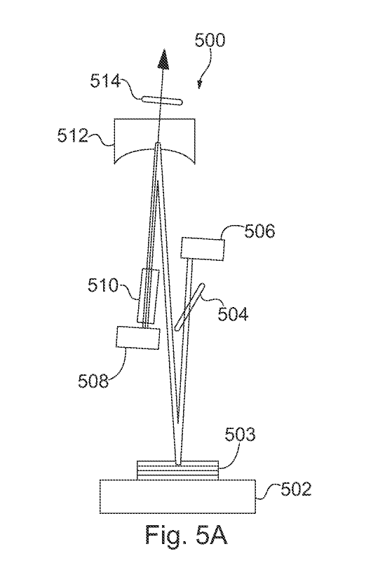

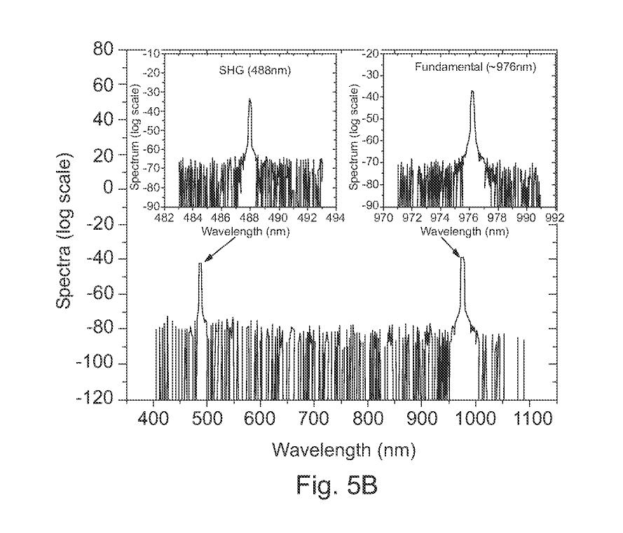

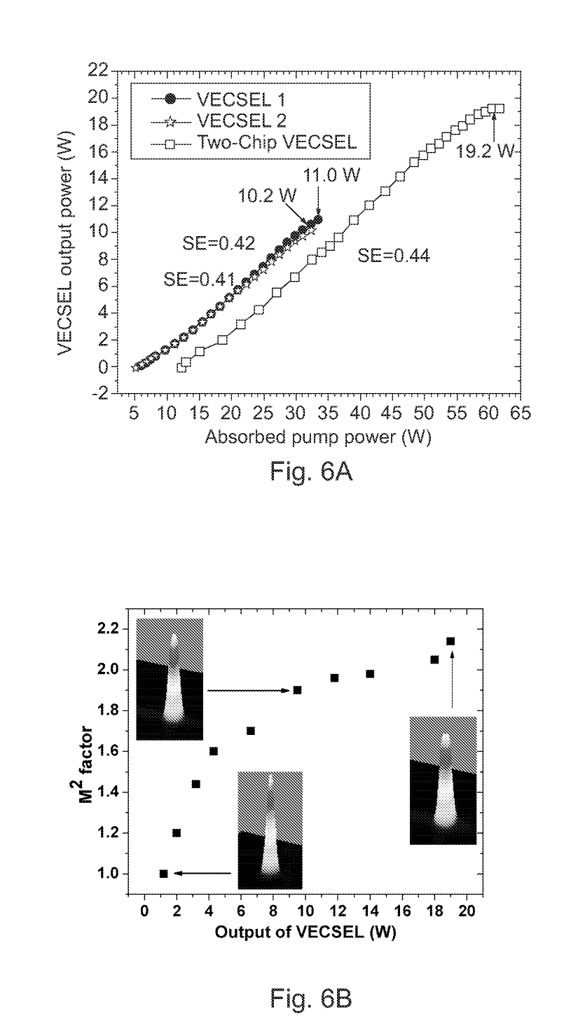

### DETAILED DESCRIPTION

To develop a dual-wavelength pump for the generation of coherent THz wave by DFG, the present invention provides a dual-wavelength oscillating VECSEL 700, e.g., FIG. 12. By using an intracavity tilted Fabry-Perot (FP) etalon 708 with proper thickness, two lasing wavelengths, separated by a few nanometers, can be selected by two adjacent resonances of the etalon 708 simultaneously. Of course, the filter, e.g. etalon 708, is not limited. It can be other wavelength selective components.

The prerequisite for dual-wavelength operation in a laser is that the laser must have “intrinsically broadened” gain. The “intrinsically broadened” is defined herein as “broadening of the quantum-well gain via the interactions among the optically excited electrons, and/or via the interactions of electrons with phonons, and/or via the unavoidable growth inhomogeneities and/or imperfections of the quantum well.” This should be distinguished from deliberately engineered inhomogeneities such as two or more quantum-well types with shifted gain peaks to match the dual wavelength. The lasing spectrum of the VECSEL 700, and in particular the lineshape of the laser gain, is the direct evidence of the intrinsic broadening. So the VECSEL 700 has potential to realize dual-wavelength operation with a few nanometer wavelength differences.

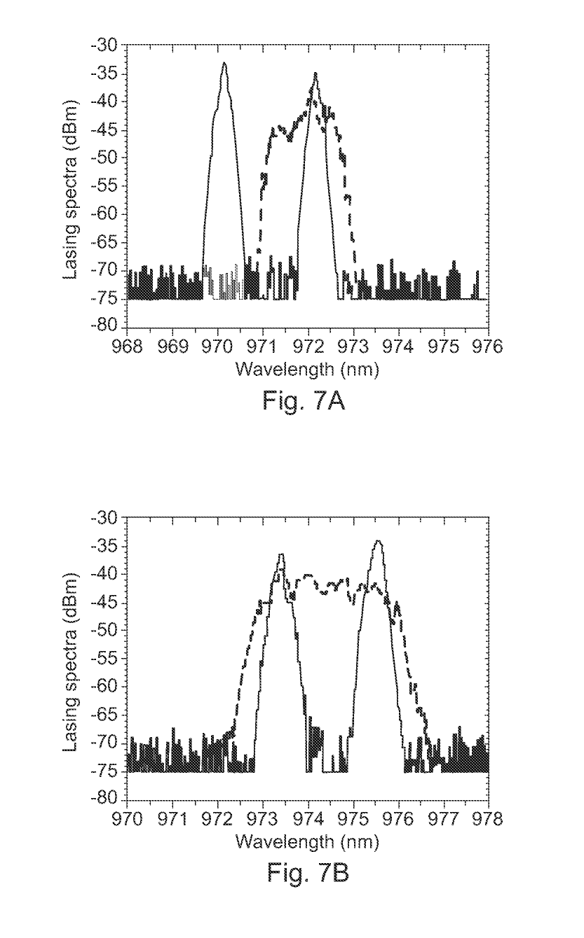

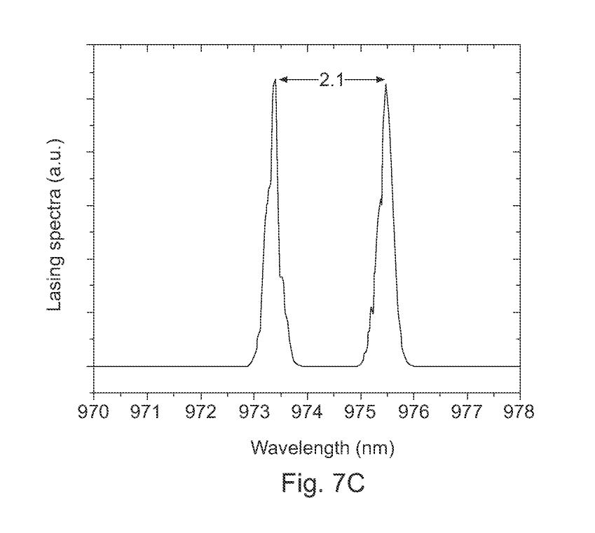

As a proof of feasibility, we inserted an etalon 708 (a piece of 150 μm thick glass slide without any coating tilted at small angle) in the cavity of our V-shaped VECSEL cavity, FIG. 12. Also included in the arrangement shown are a VECSEL chip 710, Brewster window 706, HR flat mirror 704, and output coupler 714. The glass slide behaves as a low finesse Fabry-Perot cavity. The thickness of the glass provides a free spectral range of about 2.1 nm. The preliminary results, with 2.1-nm wavelength separation and a side-mode suppression of 30 dB are shown in FIG. 7C. The measured output powers are 4.78 W and 4.5 W without and with etalon 708, respectively. These initial results indicate that by using a high finesse Fabry-Perot etalon 708 inside the VECSEL cavity, the laser can operate simultaneously at two single-frequencies, suitable for THz generation using DFG method.

More specifically, the VECSEL structure, designed for emission around 975 nm, was grown by metal-organic vapor phase epitaxy on an undoped GaAs substrate. The active region consisted of 14 InGaAs compressive strained quantum wells. Each quantum well was 8 nm thick and surrounded by (˜31 nm thick) GaAsP strain compensation layers and AlGaAs pump-absorbing barriers. The thickness and composition of the layers were optimized such that each quantum well was positioned at an antinode of the cavity standing wave to provide resonant periodic gain (RPG). A high reflectivity (R>99.9%) DBR stack made of 25-pairs of Al_{0.22}Ga_{0.8}As/AlAs was grown on the top of the active region. In addition to the RPG active region and DBR stack, there was a high aluminum concentration AlGaAs etch-stop layer between the active region and the substrate to facilitate selective chemical substrate removal. The epitaxial side of the VECSEL wafer was mounted on chemical vapor deposition (CVD) diamond by indium solder. After the removal of the GaAs substrate and etch-stop layer, a single layer Si₃N₄ (n=1.78 at 980 nm) quarter wave low-reflection (LR) coating (for 975-nm signal) was deposited on the surface of VECSEL chip 710 to achieve a reflectance of less than 1% at the signal wavelength. Also, this coating significantly reduced the reflectance of 808-nm pump emission at chip surface.

The experimental setup is shown in FIG. 12. A V-shaped cavity which is folded at the VECSEL chip 710 was used in the experiment. The advantages of this cavity are to double-pass the gain and increase the efficiency. To reduce its walk-off loss, the LR (<1%) coating was applied on the chip surface. The processed VECSEL chip 710 was mounted on a heat sink for temperature control. The lasing experiment was conducted by using a fiber coupled multimode 808 nm diode laser pump source. A 480 um diameter pump spot was focused on the VECSEL chip 710 during the experiment. In the V-shaped cavity, the distance between the HR (R>99.9% at signal wavelength) flat mirror 704 and the chip 710 was around 6 cm and the distance between the chip 710 and the output coupler 714 (R˜97% at signal wavelength, 30 cm radius of curvature) was about 20.5 cm. The size of TEM₀₀ mode on the VECSEL chip 710 was about 425 μm diameter, matching the pump spot size of 480 μm diameter. The cavity angle between two arms of the V-shaped cavity was about 8°, resulting in the refraction angle in the semiconductor to be less than 1.3°. Such a small refraction angle did not significantly change the relative confinement factor. Both FP etalon 708 and Brewster window 706, which were ˜150 μm thick uncoated commercial glass slides, were inserted between the chip 710 and the HR flat mirror 704 to achieve linearly polarized dual-wavelength VECSEL. By scanning the glass slide in an expanded parallel He—Ne laser beam and monitoring the interference fringes on a shear plate, we selected the desired area on glass slide, in which both sides of the glass slide were parallel and smooth. This area was aligned in the cavity to cross the laser beam. The free spectral range of the filter (etalon 708) was about 0.67 THz (or 2.0 nm).

The pump spot on the chip 710 played the role of an aperture. Since the Gaussian beam suffered from the distortion introduced by a titled FP etalon 708, this distorted laser beam in conjunction with the aperture caused more diffraction loss due to the truncation of the aperture. In the experiment we observed that inserting the etalon 708 in the longer arm of the V-shaped cavity caused lower efficiency of the laser (i.e., much more diffraction loss into the VECSEL) than placing it in the short arm.

FIGS. 7A-7C show the lasing spectra with/without both the intracavity tilted etalon 708 and Brewster window 706. During the measurement, the temperature of the heat sink was fixed at 10° C. The lasing spectral intensity (in dBm) at 16.4-W pump power is shown in FIG. 7A. FIGS. 7B and 7C show the lasing spectral intensity (in dBm and linear scale, respectively) at 26.5-W pump power. At these two pump levels, without the etalon 708 and Brewster window 706, the VECSEL lasing spectra (dashed lines in FIGS. 7A, 7C) were a few nm wide and shift with the increase of the pump power. After the etalon 708 and Brewster window 706 were inserted in the cavity as illustrated in FIG. 12, the etalon 708 was properly tilted such that the spectral intensity of each color was even and the total output power was optimized. The dual-wavelength lasing spectra selected by the etalon 708 (solid line in FIGS. 7A, 7B) indicate over 30-dB side-mode suppression. Also the dual-wavelength lasing spectra indicate similar red-shift behavior as the unfiltered lasing spectra. The dual-wavelength lasing spectrum (in linear scale) in FIG. 7C gives the linewidth (FWHM) of ˜0.5 nm for each color and the spectral spacing of 2.1 nm. Due to the lack of a suitable grating to separate these two wavelengths, we could not directly measure the power of each wavelength. Since the spectral intensity was even at two wavelengths, the power of each wavelength should be close to each other. The penalty for using intracavity components was the loss of the output power. At 26.5-W pumping, the output power was 4.78 W and 3.98 W before/after inserting both FP etalon 708 and Brewster window 706, respectively. The intra-cavity FP etalon 708 and Brewster window 706 only reduced the total output power by 17% at this pump level.

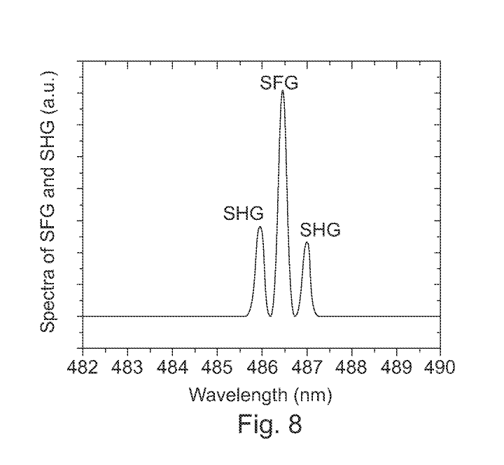

To confirm that the VECSEL oscillates at these two wavelengths simultaneously, we focused the collinear dual wavelength output into a type-I angle phase-matched lithium triborate crystal, employed to generate tunable second harmonic generation (SHG) around 488 nm, to generate sum frequency generation (SFG). Since the two wavelengths (λ₁ and λ₂) were only separated by 2.1 nm, the phase matching angle for SFG of λ₁ and λ₂ was also close to that of SHG of λ₁ or λ₂. These three nonlinear conversion signals should be observed. FIG. 8 shows the SFG (central peak) as well as the SHG of each fundamental wavelength (side peaks, separated by ˜1 nm). The SFG signal confirms that these two wavelengths lased simultaneously.

Some practical drawbacks of this linearly polarized dual-wavelength VECSEL must be mentioned. The spectral intensity at these two wavelengths is not always even. We observed that each of these two spectral peaks in FIG. 7 became dominant slowly and alternately due to the longitudinal mode competition between them. Meanwhile, dual-wavelength output power slowly fluctuated in the range of +50 mW. Thus, the challenge of developing high-power dual-wavelength VECSELs is the stabilization of the power at each wavelength, and elimination of the competition between the two wavelengths. Our initial investigation indicates that in order to weaken the mode competition and achieve large wavelength difference between two lasing wavelengths, a two-chip VECSEL with different gain peak wavelengths seems promising. In conjunction with a tilted high-finesse etalon, we can tune this two lasing wavelengths, achieve the desired wavelength difference, and force each wavelength to be in single-frequency operation.

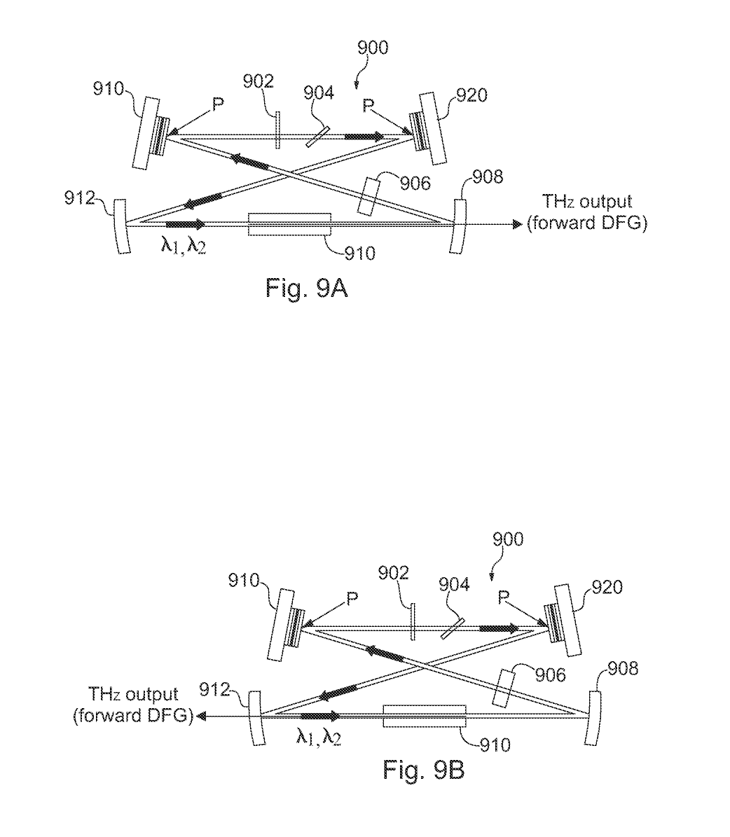

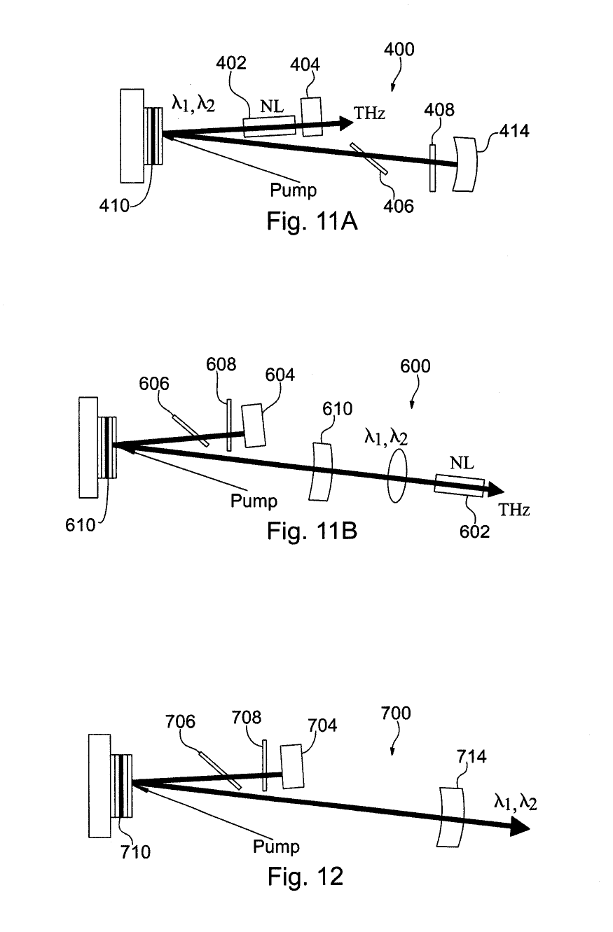

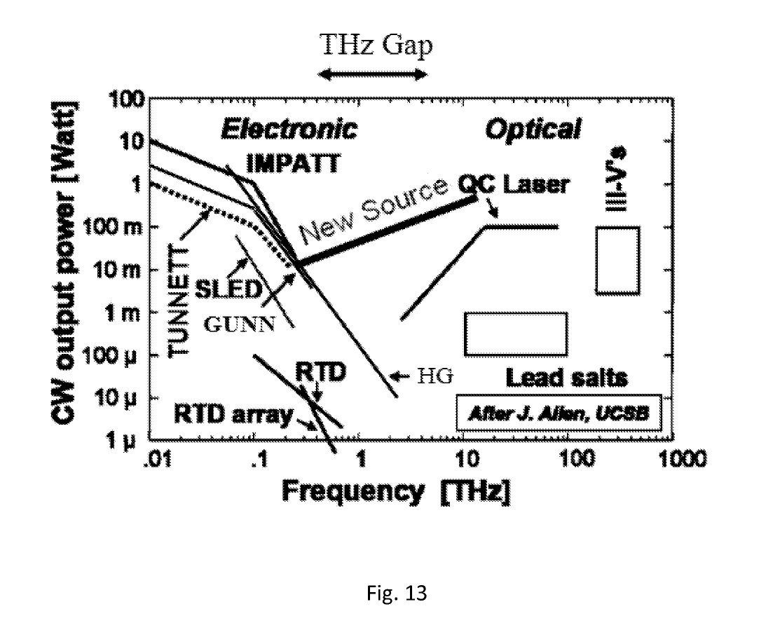

Turning to the THz generation, some of possible setups for the THz generation by intracavity DFG within the dual-wavelength VECSEL with a high Q cavity or by extracavity DFG are shown in FIGS. 9A-9B, 11A-11B. FIG. 11A-11B shows some schematic diagrams of the collinear phase-matched intracavity DFG for THz generation. The configurations 400, 600 include a VECSEL chip 410, 610, Brewster window 406, 606, filter 408, 608, NL material 402, 602, HR flat mirror 404, 604, and output coupler 414, 614, respectively. Intracavity filtering forces the VECSEL to oscillate at two wavelengths (λ₁ and λ₂). The VECSEL can have either a single chip or multiple chips. In the ring resonator, an optical diode (OD) forces the unidirectional propagation of the laser beam, FIGS. 9A, 9B. A suitable nonlinear crystal 910 is inserted at the beam waist to generate THz by DFG. The polarization of VECSEL 900, which is very important for the phase matching, is controlled by the Brewster window 406, 606, 904.

### Nonlinear Crystal Selection and Phase Matching Conditions

### Selection of Nonlinear Crystal

In order to efficiently generate THz wave by intracavity DFG (or OPO), the choice of nonlinear optical crystal and phase-matching characteristics are very critical. In order to select an optimum crystal for the efficient generation of the THz waves, we need to consider three critical issues. First, the effective nonlinear coefficient should be as large as possible. Second, the crystal must be highly transparent at the three parametric wavelengths such that a long interaction length among the three participating waves can be always maintained. Third, other competing effects such as two-photon and free-carrier absorption and nonlinear refractive index should be weak enough not to significantly affect the threshold.

In the recent study of coherent THz radiation with OPO or DFG, among the many nonlinear crystals (e.g., LiNbO₃, GaP, GaAs, DAST, GaSe), GaSe has shown the lowest absorption coefficients in the near-IR and THz wavelength regions. A low absorption coefficient is extremely important for our intracavity coherent THz generation. Furthermore, this material has a large birefringence (GaSe, having the 6 m2 symmetry, has the largest birefringence among the commonly used nonlinear-optical crystals. For example, n(o)−n(e)≈0.35 at 1 μm, where n(o) and n(e) are the indices of refraction for the ordinary and extraordinary waves inside a GaSe crystal, respectively.). Consequently, phase matching can be achieved in an ultrabroad wavelength range. Even though GaSe has the potential to reach THz optical parametric oscillation (OPO) with a single pump beam, DFG offers relative compactness, simplicity for tuning, straightforward alignment, much lower pump intensities, and stable THz output. Indeed, unlike OPO, DFG does not require a complicated alignment procedure, even if wavelength tuning is required. The high second order NLO coefficient (d₂₂=54 pm/V) and large figure of merit d_{eff}²/n³ for GaSe make that efficient THz generation. This is extremely important for intracavity DFG since the pump laser, VECSEL, operates in IR band (˜1 μm). As a result, we will initially use GaSe for carrying out our intracavity DFG experiment.

For type-oee phase-matching (PM) interaction (o and e indicate ordinary and extraordinary polarization, respectively, of the beams inside the GaSe crystal), the effective NLO coefficients for GaSe depend on the PM (θ) and azimuthal φ angles as d_{eff}=d₂₂ cos² θ cos³ φ. To optimize d_{off}, azimuthal angles of φ=0°, 60°, 120°, 180° can be chosen such that cos³ φ=1.

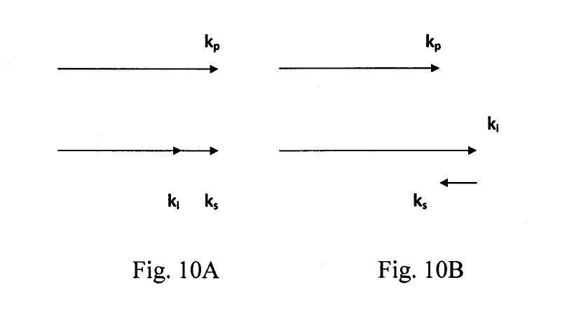

Collinear DFG allows two wave propagation configurations: forward and backward, shown in FIG. 10. The amounts of birefringence for the nonlinear material required for phase matching are different for these two.

The phase matching condition for a parametric down-conversion is determined by simultaneous solution of the photon energy conservation and photon momentum conservation. The general phase matching conditions case (birefringent phase-matching (PM) or quasi-phase-matching (QPM)) are given by:

$$\{ \begin{matrix}1 / {λ}_{p} = 1 / {λ}_{s} + 1 / {λ}_{i} \\ {n}_{e} ( {λ}_{p} , θ ) / {λ}_{p} = {n}_{o} ( {λ}_{i} , θ ) / {λ}_{i} + {n}_{o} ( {λ}_{s} , θ ) / {λ}_{s} + 1 / Λ\end{matrix} \\ ( for Forward configuration ) \\ \{ \begin{matrix}1 / {λ}_{s} = 1 / {λ}_{p} + 1 / {λ}_{i} \\ {n}_{o} ( {λ}_{p} , θ ) / {λ}_{p} = {n}_{e} ( {λ}_{i} , θ ) / {λ}_{i} - {n}_{o} ( {λ}_{s} , θ ) / {λ}_{s} + 1 / Λ\end{matrix} \\ ( for Backward Configuration )$$

where Λ is the spatial period of the poled region of the poled region. If the material is not periodically poled, the grating Λ=∞. The phase-matching condition for non-collinear OPO can be obtained similarly, but it is slightly complicated since three waves are not collinear. Combining phase-matching condition with Sellmeier equations (a set of the dispersion relations for nₑ and nₒ), the phase-matching angle can be found, but the solved angles is not unique. One always chooses the angle which gives optimum d_{eff}.

The advantage of backward DFG and output of THz are discussed by Ding et al. Neglecting the absorption for all three parametric waves, the output peak power is given by

$${P}_{THz} = ( \frac{{π}^{2}}{4} ) ( \frac{{λ}_{i}}{{λ}_{THz}} ) ( \frac{{w}_{THz}^{2}}{{w}_{i}^{2}} ) \frac{{P}_{P} {P}_{i}}{{I}_{th} π {w}_{P}^{2}}$$

where wₚ, wᵢ, w_{Thz} are the beam radii for the pump, idler and THz beams, respectively, and Pₚ, Pᵢ are pump and idler peak powers, respectively. This equation shows that increasing the pump and idler power while decreasing their beam sizes can significantly improve the output of THz. The intracavity OPO or DFG will take these advantages to efficiently generate THz radiation. In above equation, Iₜₕ is the threshold intensity for achieving the backward THz OPO after neglecting the absorption of the three waves, given by

$${I}_{th} = \frac{{λ}_{i} {λ}_{THz} {n}_{o} ( {λ}_{i} ) {n}_{e} ( {λ}_{THz} , θ ) {n}_{e} ( {λ}_{P} , θ )}{8 {η}_{0} {d}_{eff}^{2} {L}^{2}}$$

where η₀ is the vacuum impedance and L is the crystal length.
Generation of CW High-Power Coherent THz Radiation with Intracavity DFG High-Power Dual-Wavelength VECSEL—A Two-Color Pump Source for DFG

The generation of THz radiation by DFG method requires the availability of two high power lasers sources with frequencies f1 and f2 such that Δf=f2−f1 correspond to the desired THz frequency. By changing f2−f1, one can achieve tuning of the THz source. One major challenge in DFHG is accurate and stable control of f2−f1 under various operating conditions. This is usually achieved by using two independent sources with very high stability. However this makes the system very costly and large. A very attractive alternative for cost and size reduction is to deploy a pump source capable of generating two stable colors (two wavelengths) with high purity. In addition for the generation of coherent THz wave by intracavity DFG, the collinear configuration makes alignment significantly easier than other configurations. As a result the most desirable pump source would be a high power semiconductor laser capable of generating two coaxial beams simultaneously, while sharing the same optical cavity. A theoretical model for such a laser was proposed by Morozov et al. An optically pumped dual-wavelength (984 nm and 1042 nm) VECSEL was reported recently. This laser is based on a complicated design and a critical epitaxial growth of the VECSEL chip. However, its lasing spectrum at each color has a few nm wide linewidth. To avoid the cross talk between two wavelengths, they have to be largely separated by ˜60 nm. Compared to other regular 980-nm VECSELs, the performance of this laser was very poor (less than 1-W saturated output power and slope efficiency of ˜16%). The laser also indicates self-pulsation. Obviously this dual-wavelength VECSEL cannot be a light source for THz generation by DFG.

### Intracavity DFG

To generate and extract a coherent THz radiation from nonlinear crystal, the VECSEL with unidirectional ring resonator will be employed. FIGS. 9A-9B show the schematic diagram of a proposed collinear phase-matched intracavity (forward and backward) DFG for THz generation. The VECSEL cavity consists of a stable ring cavity, including mirrors 908, 912 and two different VECSEL chips 910, 920. Both mirrors 908, 912 are high reflecting around 980 nm, and transparent for THz, serving as THz output coupler. In case a backward DFG scheme is chosen, mirror 912 would be the output coupler for THz. If forward DFG scheme is employed, mirror 908 serves as the output coupler. In the ring cavity, a high finesse FP etalon 902 forces the VECSEL oscillating at two single frequencies (λ₁ and λ₂) around 980 nm. An optical isolator 906 forces the unidirectional propagation of the laser beam. In this cavity, the smallest mode size is at the center between mirrors 908, 912. A nonlinear crystal 910 would then be placed between these mirrors 908, 910. The polarization of VECSEL, which is very important for the phase matching, is controlled by the Brewster window 904. Collinear DFG is very convenient for the alignment when the pump wavelengths of DFG are tuned. The difference of λ₁ and λ₂, which determine the frequency of THz wave, is controlled by BF and FP etalon 904, 902.

Having a intracavity circulating power of over 200 W, we anticipate to generate a coherent THz radiation with a power in the range of 1-5 mW. The whole device will be very compact and significantly lower cost than the available THz sources.

Based on the concept according to the present invention, first demonstration experiments have already been carried out by us, apart from detailed theoretical calculations and estimations, which firmly prove the far reaching potential of the our approach to THz generation.

### Exemplary Components of the Devices (in Some Practical Embodiments)

### Vertical External Cavity Surface Emitting Laser (VECSEL)

A VECSEL comprises a semiconductor structure composed of two different sequence layers. The first area of the structure is comprised of a sequence layer of quantum films, which are responsible for the laser activity, followed by an underlying Bragg mirror. Thus, the VECSEL chip itself provides one mirror of the laser resonator, whilst all further mirrors are located outside the semiconductor material. By means of a pump laser, the semiconductor material is optically excited. Alternatively, the excitation may also be achieved electrically. Through a suitable resonator configuration, a laser emission is achieved.

Through the use of frequency filtering elements inside the resonator, it is possible to limit the emission spectrum of the laser to certain frequencies within its gain spectrum. Such an element is, for example, an etalon which enables the limitation, upon suitable choice, of the emission spectrum to one or various frequencies. With two- or multi-color emission, it is possible to generate new emission wavelengths by means of nonlinear optical elements for frequency conversion (SHG, THG, difference frequency generation (DFG)).

### Nonlinear Crystals for Frequency Conversion

Nonlinear crystals are suitable for frequency conversion according to the present invention, i.e., for frequency multiplication or up-conversion, as well as for difference-frequency generation. For that, their high χ⁽²⁾ factor, which is denominated second order electrical susceptibility, can be decisive, whereby it is possible to carry out a frequency conversion of the irradiated laser light, provided that the laser intensity is sufficiently high in order to generate a measurable, converted output signal. Many different material compositions are eligible as the nonlinear material, but, for each application, it has to be accurately checked beforehand which of the available materials is most suitable. Attention has to be paid to the respective absorption of the individual frequencies inside the crystal, as well to the phase matching between the generating and generated electromagnetic radiations. The latter represents a non-trivial challenge, as insufficient phase matching leads to a strongly reduced output signal, because the generated frequency components are attenuated again or completely extinguished by destructive interference. In order to ensure phase matching, three techniques have been examined. Ultimately, concerning the invention it has been shown that: firstly, an adjustment is able to be achieved by birefringence of the crystal, secondly by quasi phase matching (QPM), and thirdly by a waveguide configuration.

### Matching Via Birefringence

Many nonlinear crystals feature birefringent characteristics, i.e. the refraction index depends on the polarization direction of the electromagnetic wave relative to the crystal axis. Hereby, ordinary and extraordinary beams are differentiated. If a birefringent crystal is cut at a certain angle, then the effective refraction index of the extraordinary beam is able to be modified as a function of the cutting angle. Phase matching is achievable through this principle.

### Quasi Phase Matching

QPM is also able to be—for the realization of the invention—achieved, where ferroelectric domains are oriented opposing one another alternately in a crystal in the distance which corresponds to the half wavelength of the incoming laser light in the material. A weakening of the generated frequency through destructive interference is avoided, and the generated intensity of the electromagnetic irradiation increases with the path length in the crystal through the periodic pole reversal of the domains. Periodically poled lithium niobate (PPLN), along with many other materials, is a known representative. PPLN was used in the first demonstration of the technology applied for here in the patent and is described further below.

### Waveguide Geometry

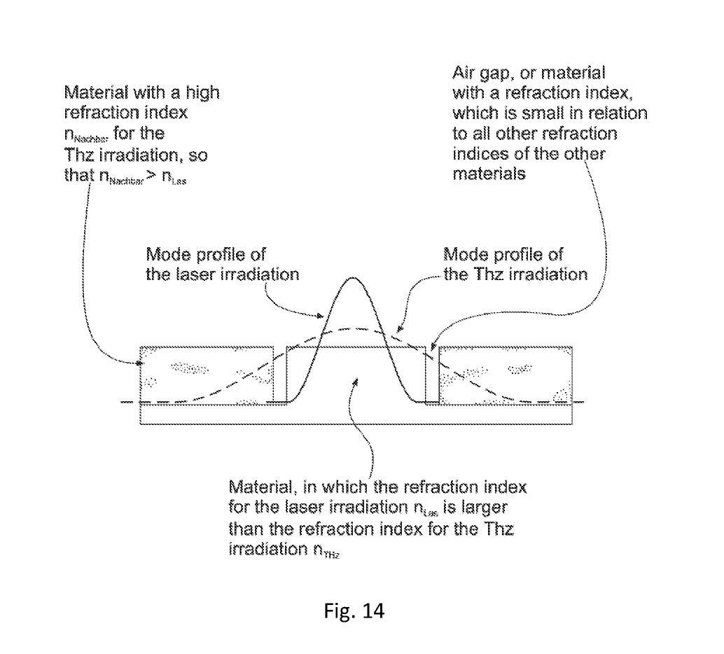

Phase matching according to the present invention is also suitable for being achieved in that the nonlinear material is structured in order to realize a waveguide geometry, FIG. 14. The aim of such a structuring is to achieve an identical effective refraction index of the nonlinear material for the laser wavelength and of the nonlinear material for the THz irradiation in the waveguide region, or refraction indices which only vary from one another as little as possible. In order to realize this, all waveguide configurations described in textbooks are available (see e.g. Karl J. Ebeling, Integrierte Optoelektronik, Springer, Berlin, 1992). Examples of this are raised strip waveguides, flushly embedded strip waveguides, buried strip waveguides, ridge waveguides, inverted ridge waveguides, dielectric slab waveguides, metal slab waveguides. However, countless further possibilities exist since the nonlinear material can be combined with other materials having a refractive index suitable to achieve phase matching.

Additionally, waveguides and/or nonlinear materials, which comprise photonic crystal structures or depend on so-called metamaterials with a negative refraction index, are also possible.

A high intensity of the laser irradiation in the crystal is necessary for a large conversion efficiency. Unfortunately, all materials possess a damage threshold. This effect is called “photorefractive effect” or “optical damage” with lithium niobate and is described in A. Ashkin, et al., “Optically-induced refractive index inhomogeneities in LiNbO₃ and LiTaO₃”, Appl. Phys. Lett., vol. 9, 1966. Due to the high laser intensity within the crystal, an alteration appears in the local refraction index and absorption ratio, which bends the laser beam and, consequently, ends the laser activity. However, this effect is reversible and is able to be reduced through intense heating of the crystal to temperatures around 170° C. or higher. To avoid these effects one has to increase the effort of temperature stabilization considerably. On the other side, the intensity of the optical damage is able to be reduced through the doping of the LN with MgO. Thus, it can be advantageous to use MgO-doped LN (the material which is also used in the prototype of the present invention) as the crystal material for an improved efficiency.

While LN is promising for application in difference frequency generation (DFG) due to its large nonlinear coefficient, its high absorption of THz waves simultaneously prevents an application in a collinear assembly. In order to counteract this problem, a surface-emitting, intracavity THz-DFG concept was also used according to the present invention. Surface emission of coherent THz irradiation, which was generated through a DFG process, is able to be generated with a PPLN crystal.

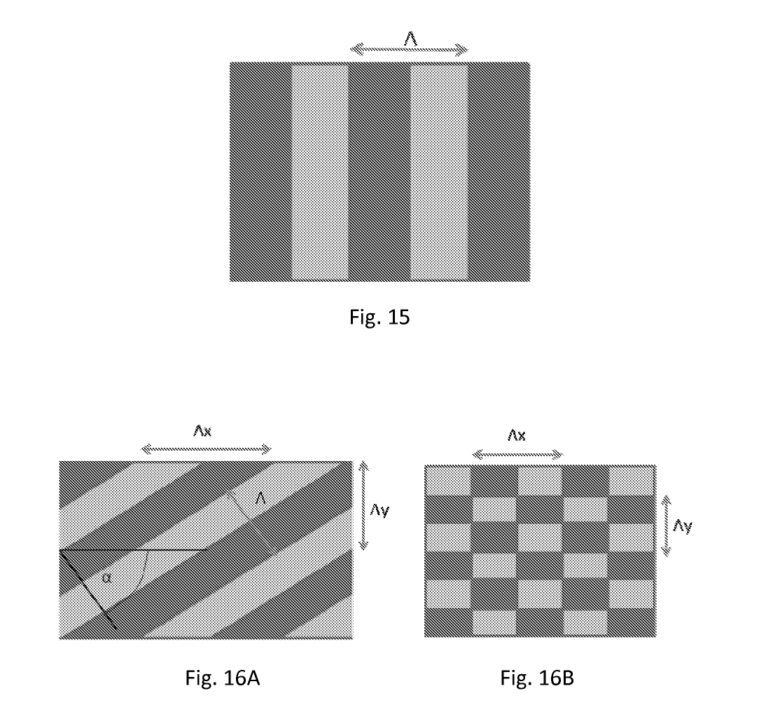

A simplest design of a PPLN is shown in FIG. 15. For an efficient surface emission, the polarity period A should be chosen as follows:

$$Λ = \frac{{λ}_{THz}}{{n}_{IR}}$$

Wherein n_{IR} is the refraction index of the IR wave and λ_{THz} is the free-space wavelength.

In order to avoid destructive interference of the generated THz radiation, with use of this simplified design, and in order to obtain a high THz output power, it is desirable to use a very low diameter of the laser irradiation within the PPLN. However, the useful crystal length is limited through the divergence of the laser ray. Hereby, it has to be mentioned that the smaller the ray diameter chosen, the larger the resulting ray divergence is.

While the simple PPLN design shown in FIG. 15 suffices for VECSEL systems with low IR power, the DFG THz prototype introduced here for the first time is based on an expanded crystal design. A tilted periodically poled lithium niobate (TPPLN) crystal was used, in order to no longer be limited through an IR ray diameter which is too small, FIG. 16A. This structure is tilted in reference to the crystal surface. Thus, periodic polarity also occurs in the direction of the radiated THz wave. Subsequently, the destructive interference of the THz wave is compensated through this, and the IR ray diameter is able to be chosen considerably larger without reducing the conversion efficiency. Here it is noteworthy, that even with a chessboard example, as is shown in FIG. 16B, a periodic 2D polarity, whose behavior is comparable with the TPPLN structure, is able to be realized. Both are suitable for being used according to the present invention.

For high conversion efficiency, the parameters should be determined as follows:

$$tan ( α ) = \frac{{n}_{THz}}{{n}_{IR}} , \\ Λ = \frac{{λ}_{THz}}{{n}_{IR}} cos ( α ) , \\ {Λ}_{x} = \frac{{λ}_{THz}}{{n}_{IR}} , \\ {Λ}_{y} = \frac{{λ}_{THz}}{{n}_{THz}} .$$

Wherein n_{IR} is the refraction index of the IR radiation, n_{THz} is the THz refraction index and λ_{THz} is the free-space wavelength of the THz irradiation. Furthermore, α is the tilting angle and Λ is the polarity period.

In the past few years, it has been shown that electro-optical polymers comprise a nonlinear χ⁽²⁾-coefficient, which is sufficient for generating THz waves by means of difference frequency generation (or optical rectification) (see, for example, L. Michael Hayden, et al., “New materials for optical rectification and electro-optic sampling of ultra-short pulses in the THz regime”, J. Polymer Sci. B. Polymer Phys, vol. 41, pp. 2492-2500, 2003; A. M. Sinyukov, et al., “Efficient electro-optic polymers for THz applications”, J. Phys. Chem. B, vol. 108, pp. 8515-8522, 2004; Xuemei Zheng, et al., “Broadband and gap-free response of a terahertz system based on a poled polymer emitter-sensor pair”, Applied Physics Letters, vol. 87, no. 8, pp. 081115, 2005).

Thus, a further class of materials is available which is suitable for being applied as a nonlinear medium according to the present invention.

Silicon is also suitable for being used as a nonlinear medium. Normally, silicon does not comprise a nonlinear χ⁽²⁾-coefficient. However, in Rune S. Jacobsen, et al., “Strained silicon as a new electro-optic material”, Nature, vol. 441, pp. 199-202, 2006, it is shown that a significant nonlinear coefficient can be achieved in silicon through a strain-induced symmetry breaking Strained silicon is suitable for being subsequently applied as a nonlinear material for generating THz radiation.

Frequency Conversion within a Cavity (Preferably) SHG

The arrangement of the nonlinear element within the resonator lends itself to frequency conversion, since the optical intensity here is significantly higher than with the use of the outcoupled laser beam. Thereby, the conversion efficiency increases by a considerable amount because the nonconverted laser power does not become lost, but rather is reflected through the resonator mirror back through the crystal. Thus, even low conversion efficiency is sufficient to achieve high resulting frequency conversion efficiency with a simple cycle through the crystal.

### Design of the Prototypes

It is mentioned here that the experimental design introduced here actually represents an example of an embodiment however other embodiments or working examples are likewise able to be realized.

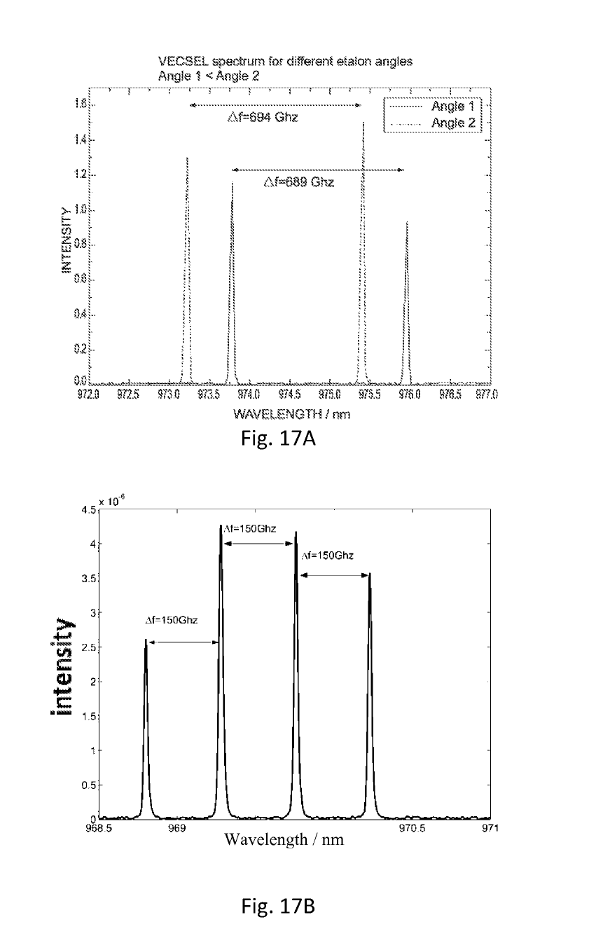

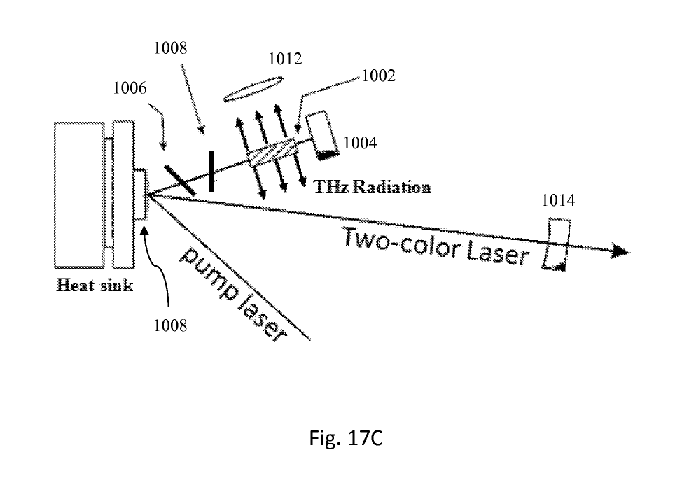

The schematic drawing in FIG. 17C shows the design of the two color VECSELs used in our prototype, which is already realized. These VECSELs comprised a nonlinear crystal 1002 and THz optics 1012. The nonlinear material 1002 comprised lithium niobate (LN) with tilted, periodic polarity (TPPLN).

The laser design used comprised a V-shaped resonator, which was limited by two mirrors, a convex output coupler 1014 with a reflectivity of 97% and a highly reflective, planar mirror 1004 with a reflectivity of over 99%. The active laser medium 1010 was located on top of a heat sink at the folding point of the resonator and was pumped by a pump laser which emitted at a wavelength of 810 nm.

Further elements used include an etalon 1008 for generating two or more wavelengths, as shown by both of the spectra in FIGS. 17A, 17B. It was also possible to shift the difference frequency in certain boundaries through tilting of the etalon 1008. A Brewster window 1006 was also used for the adjustment of the polarization of the laser radiation and THz optics 1012 were also used for the bundling and focusing of the emitted THz waves onto a detector. The THz radiation was able to be detected with a bolometer, a Golay cell and a pyroelectric detector. (The detector and the second THz lens are not represented in FIG. 17C.)

The placement of the nonlinear crystal 1002 was realized near the highly reflective mirror 1004, because here the laser beam achieved its lowest diameter within the resonator.

With the tilted orientation of the polarity of the nonlinear crystal 1002 used, the outcoupling of the THz radiation out of the crystal 1002 was able to occur advantageously at a right angle to the propagation direction of the laser beam. Most of the nonlinear crystals are transparent for the laser radiation but more or less absorb the THz waves. Outcoupling of the THz radiation out of the side surface of the crystal 1002 reduced the distance which the THz wave had to cover and, consequently, also the absorption within the crystal 1002. Furthermore, a lateral outcoupling of the electromagnetic THz wave out of the crystal 1002 also meant considerably easier access to the radiation, as well as considerably simpler positioning of the THz optics 1012, since there were no optics of the laser resonator in this region.

In order to ensure efficient generation of the THz radiation, phase matching has to be present between the laser radiation and the THz wave. According to the present invention, this was achieved through use of periodically poled materials. Thus, in this design, periodically poled lithium niobate, which was doped with MgO, was used, in order to raise the damage threshold.

### First Experimental Results

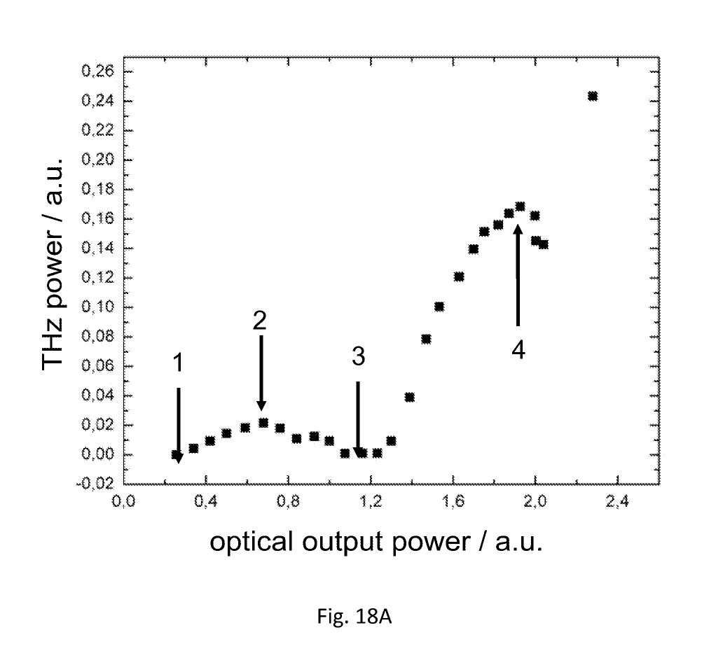

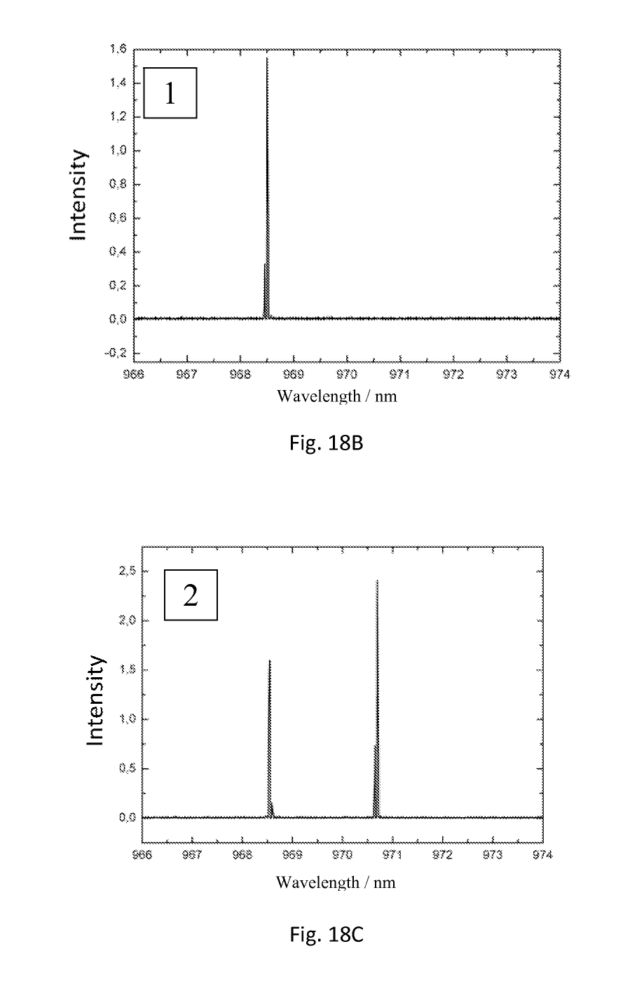

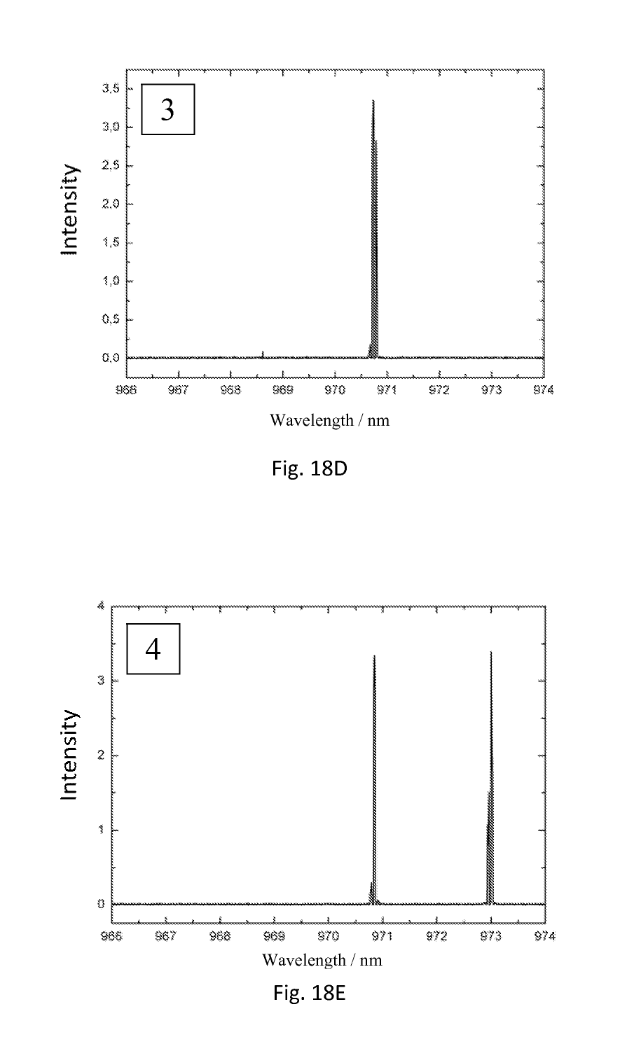

In this section, the experimental results which have been achieved with the prototype are presented. In FIG. 18A, the first outcome of measuring the THz radiation generated is shown as a function of the optical power which is coupled out of the laser cavity. The THz output power is presented in a.u. (arbitrary units) and has been measured relative to a calibration source. Even though the power of the calibration source is currently not known with high precision, it is estimated to be in the microwatt range. Additionally, four spectra for different output powers, which were recorded by an optical spectral analyzer, are presented, FIGS. 18B-18E.

These spectra prove that the measured detector signal only comes from the THz radiation, which was generated by means of difference frequency generation (DFG) in the TPPLN 1002. It can clearly be seen that the bolometer signal only takes on values different from zero when both laser lines are simultaneously present (spectra #2, FIG. 18C, and #4, FIG. 18E). With the output powers in which the spectra #1, FIG. 18B, and #3, FIG. 18D, were recorded, only one laser line oscillated and, thus, no DFG process takes place and no THz wave is generated. The signal disappears and simply existing noise is measurable.

With increased optical output power and, thus, increased power within the laser cavity, a thermally induced red-shift of the laser lines is observable. This shift has no effect on the DFG process, since the difference frequency remains constant. This depends only on the intracavity etalon and not on the laser power.

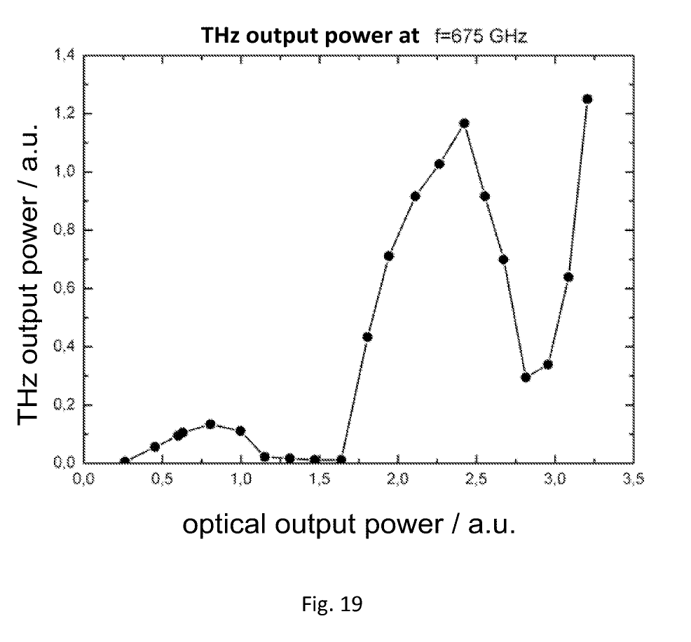

After a design improvement of the THz optics, in which the spherical lens directly in front of the TPPLN 1002 was replaced by a cylinder lens, a larger part of the emitted THz power was suitable for being captured and focused on the detector, in this case a Golay cell. This leads to a THz signal whose intensity was increased by more than a factor of 5, as depicted in FIG. 19. Here, it has to be observed that only the radiation which was emitted from one of both of the sides of the TPPLN is captured.

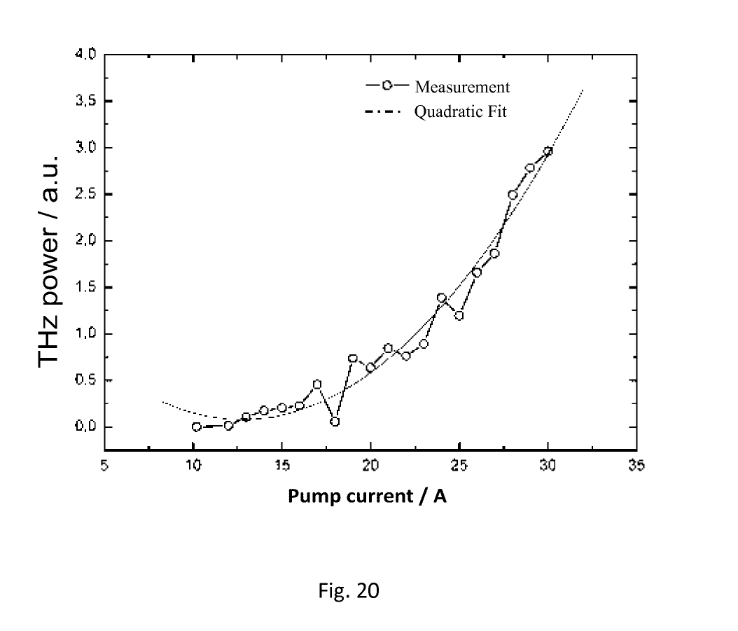

After a further design improvement, in which the resonator configuration was optimized in this case, the THz output power was able to be increased by more than a factor of 2 as the measurement in FIG. 20 shows. This was achieved through a further concave, highly reflective mirror outside of the actual resonator. With this measure, which only represents an intermediary stage towards a more efficient resonator configuration, it was able to be shown that the optical laser power in the resonator is able to be increased considerably, which is expressed in a significant increase of the THz signal.

Despite the impressive results already achieved, it should be noted again here that the experimental realization presented only has exemplary character. Until now, neither definitively optimized VECSEL geometries, laser materials, nonlinear crystals, nor extraction configurations have been used. Conservative estimates extrapolate the THz power to milliwatts and beyond. The further improvements and expansions of our laser-based source for THz and millimeter waves according to the present invention are discussed in the following section.

### Embodiment Types

A central idea in one of the aspects of the present invention is generating terahertz radiation through difference-frequency generation by means of a non-linear medium positioned within the laser resonator of a laser. This terahertz radiation is then suitable for being extracted and led over a suitable THz optics.

In the following, embodiment types of laser media, resonator configurations, nonlinear media and THz optics are presented separately, respectively. The invention results from any combination of the represented embodiment.

### Laser Media

### Semiconductor Materials

Preferably, semiconductor-based laser media, i.e. lasers as known by the English term “Vertical External Cavity Surface Emitting Laser (VECSEL)” or the German term “Halbleiter Scheibenlaser” (semiconductor disc laser), may be used in the present invention. The spectral position of the gain region is suitable for being adjusted through the material system used and structural parameters of the individual semiconductor layer (material composition and measurement). Since no principal limitation, in reference to the laser wavelengths, exists for generating THz, it is possible, in particular, to design the active structure in such a way that a pump laser, which is as reasonably priced and/or powerful as possible, is suitable for being used.

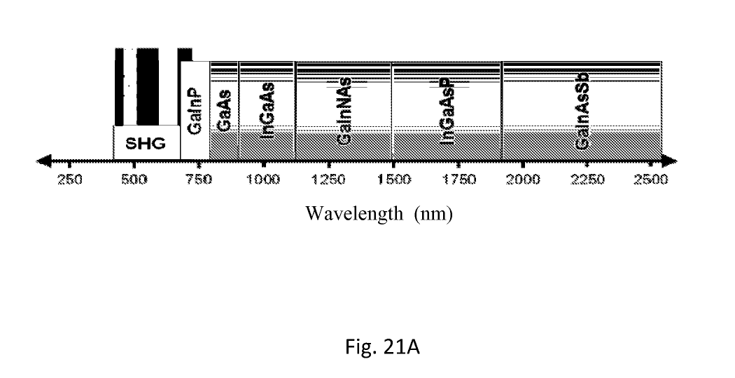

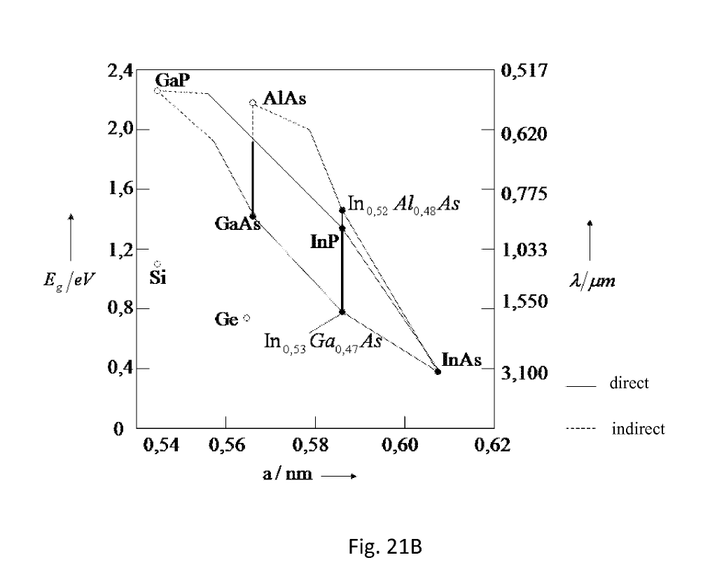

Principally, the laser wavelengths are suitable for being chosen freely in a large range. The spectral range extends from the visible frequencies up to 6 micrometers. FIG. 21A shows, as an example, which material systems are suitable for being called on for laser wave lengths between 700 nm and 2.5 μm. This plot, however, only has exemplary character. It is in no way definitive, i.e. a certain laser wavelength is also suitable for being realized through use of another material system not shown here.

In this, attention must be paid, as a rule, that the different semiconductor materials within the VECSEL structure are able to be deposited on one another either unstrained or with only targeted straining applied. A prerequisite is a similar lattice constant. Only in this way is such a high structural performance of the laser structure ensured. FIG. 21B shows, as an example, the lattice constants and band gap energies of several semiconductors for the visible to infrared wavelength region.

With the prototype described above, a VECSEL design was chosen which was identical with the “Dual Wavelength VECSEL” described on pages 3-5 of U.S. 61/067,949, with the difference, however, that another nonlinear crystal was mounted tightly in front of the planar, highly reflective mirror in the prototype presented here.

### Laser Crystals

So-called disc lasers are also suitable for being used in devices of the present invention. In this class of laser, doped crystals are applied as the active material. Currently, Yb:YAG (ytterbium-doped yttrium aluminum garnet), which emits at a laser wavelength of 1030 nm, is primarily used as the laser material for disc lasers. There are, however, also a multitude of other materials which have already been applied or are suitable for being applied in the future. Examples are Nd or Yb doped YAG, YVO4 or LaSc₃(BO₃)₄ (LSB), Yb:KYW, Yb:KGW, Yb:KLuW and Yb:CaGdAlO4 (Yb:CALGO), Yb:Y₃Sc₂Al₃O₁₂, Yb³⁺:Y₃Al₅O₁₂, Cr⁴⁺:Y₃ScₓAl₅₋ₓO₁₂. The laser wavelength as well as the optimal pump wavelength change with the material used. Disc lasers emit outputs in the kilowatt range, so that very high THz powers are suitable for being achieved as long as the nonlinear crystal is not damaged.

### Doped Glasses

Doped glasses, as they have long been known for the production of fiber lasers, are also suitable for being used as the laser medium. For that purpose, a multitude of dopants from the class of noble earths (scandium, yttrium, lanthanum, cerium, praseodymium, neodymium, promethium, samarium, europium, gadolinium, terbium, dysprosium, holmium, erbium, thulium, ytterbium and lutetium) and different glass types (quartz glass, fluoride glass, ZBLAN, INDAT, . . . ) are available.

### Resonator Configurations

The resonator is the central element of a laser and has a decisive influence on the output capability of the entire system. An almost unmanageable multitude of resonator configurations are known from the literature, since a certain resonator configuration proves optimal for each application purpose. In the following, an overview of the possible resonator types, which are also suitable for finding application in the device according to the present invention, is given.

Generally, stable, limitedly stable and unstable resonators are suitable for being applied according to the present invention.

### Stable Resonator

Resonators are designated as stable when a paraxial light beam is reflected back and forth any number of times between the mirrors in the resonator and does not leave the resonator any more, provided diffraction losses are disregarded. There are, however, limits, in which the geometric measurements of a resonator configuration are only allowed to be located so that the resonator is still stable. A resonator is very sensitive to mechanical alterations (vibrations) and misadjustments at the stability limits, i.e., in this range, a resonator is able to switch easily from the stable to the unstable region, which in many lasers leads to an interruption of the laser activity. Examples of stable resonators are, e.g., semi-confocal and concave-convex, at the stability limits, such as e.g. plane-parallel, concentric (spherical), confocal and hemispherical configurations.

### Limitedly Stable Resonator

In this configuration, a blend is brought into the stable resonator, preferably near one or several mirrors, in order to cause a mode selection. In this way, e.g., it is able to be achieved that only the base mode expands in the resonator, however, all higher longitudinal and transversal modes experience losses and do not start to oscillate.

### Unstable Resonator

These resonator types are constructed in such a way that a paraxial laser beam leaves them after a certain number of resonator cycles. This configuration is used in laser systems which comprise high power or amplification, since here, in the case of a stable resonator, the power density on the mirrors is able to exceed the damage threshold.

### Embodiments of Resonators

In the simplest case, a linear resonator is able to consist of two mirrors, between which the light wave oscillates back and forth and a standing wave is formed. It is just as possible to place any amount of mirrors between these two end mirrors and, thus, to redirect the light wave in any desired direction. Known resonator configurations are V or W-shaped. There are also other “folds” possible.

A special form of a linear laser cavity is the multipass resonator, in which the active medium is passed through at different places. This is realized in that the laser beam is not reflected back in itself at the end mirrors, but rather displaced slightly, and only after a certain number of cycles does it reach its starting point.

A further realization form of resonators is the ring resonator. In this, no standing wave is generated through interaction of the light wave moving back and forth, but rather the cycle direction is determined through the application of an optical isolator within the resonator or a highly reflective mirror outside of the resonator. It is, however, just as possible to forgo both of these elements and to allow for two waves cycling in opposite directions in the resonator.

Elements, which are suitable for being applied within a laser resonator, are not only limited by the active laser material, but it is also possible to introduce a multitude of the most different components. In this way, e.g. lenses, etalons, Brewster windows, polarizing elements, to which the aforementioned optical isolator belongs, along with λ/2- or λ/4 slabs, polarizing beam parts, etc. are able to be used. Further possible elements are Pockels cells and saturable absorbers, which are applied for the generation of a pulse operation. Further materials are also able to comprise birefringent or nonlinear characteristics, like some crystals. It is also possible to apply light-conductive fibers in a resonator, as is used in a fiber laser, amongst others.

As a further point, several alternative resonator configurations, which partially differ from the usual resonator types and are applied in special areas, should be mentioned here. This includes resonators, which do not contain the typical plane, convex or concave mirror as a reflecting element, but rather gradient mirrors, cylinder or torus mirrors and prisms. Combinations of torus and cylinder mirrors also exist, so-called hybrid resonators, which comprise different stability values in two spatial directions standing perpendicular to one another. Likewise, a relatively new optical element, the GRISM, is suitable for being applied. This is primarily used for laser pulse compression and is a combination of a prism and an optical grating.

In choosing the mirror for the resonator, the mirrors are able to comprise either a broadband frequency behavior or an extremely narrow one, so that they, for example, reflect only the laser wavelength and feature a considerably reduced reflection capacity for all other wavelengths. Furthermore, dichromatic mirrors exist which comprise a highly reflective capacity for two wavelengths which differ from one another. Each of these mirror types is suitable for being used alone or also combined in a laser resonator.

In the following table, the examples listed above in the text are summarized again.

TABLE 2
Resonator types:

Stable:
semi-confocal
concave-convex
At the stability limit:
plane-parallel
concentric (spherical)
confocal
hemispherical
Limitedly (one and two-sided) stable (e.g. with apertures)
each stable resonator configuration
Unstable:
countless embodiments
Folded:
V-shaped
W-shaped
further forms
Elements in the resonator:
lenses
spherical and aspherical mirrors
etalon, Brewster window
polarizing elements (opt. isolator, λ/2- or λ/4 slabs, polarizing beam
separator)
Pockels cell
birefringent or nonlinear element
light-conductive fiber
diffraction grating
prisms
GRISMs
Alternative resonator configurations
prism resonators
with gradient mirrors
Fourier transform resonator
hybrid resonators of torus or cylinder mirrors (different g-parameters in two
spatial directions standing perpendicular to one another)
for tube shaped media (with torus mirrors)
multipass
ring
dichromatic mirror
from light-conductive fiber
waveguide

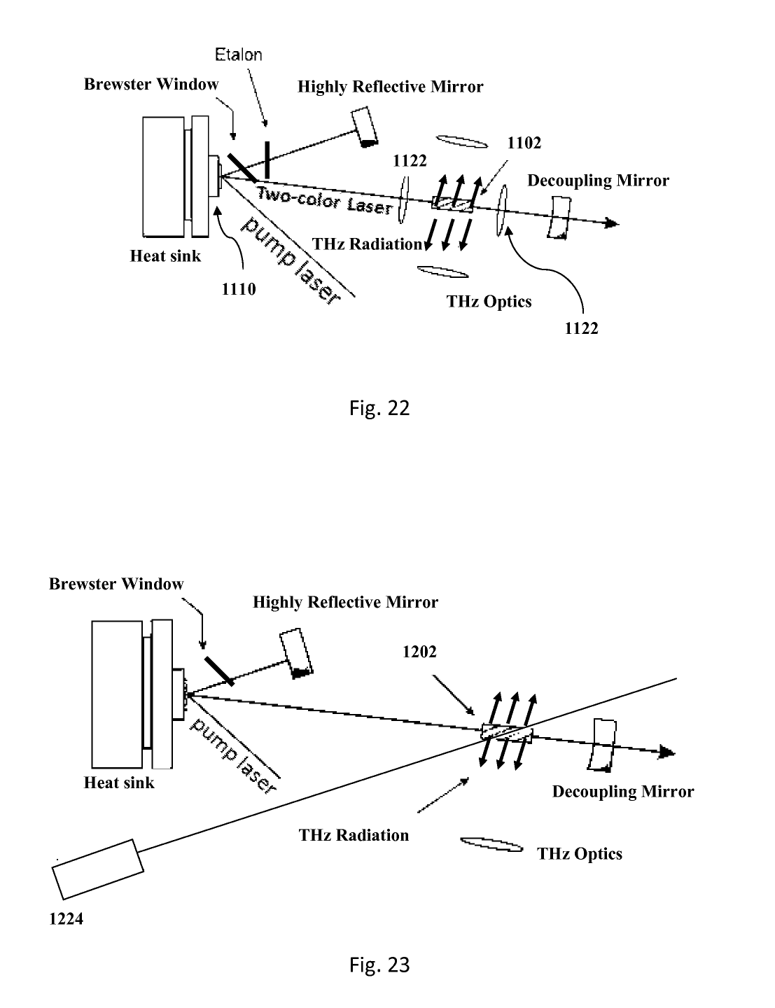

In FIGS. 22-26, several embodiments of laser resonators are depicted, which may be used with the devices of the present invention due to their good suitability. However, all of the resonator types and embodiments described above, as well as combinations thereof, are also possible. This also includes the use of the listed elements, which are suitable for being introduced in the resonator.

For example, FIG. 22 shows another possible embodiment of a resonator to extract THz signals from the 2-color VECSEL having a VECSEL chip 1110. Here two lenses 1122 are placed in the cavity to image the internal IR wave on the nonlinear crystal 1102. The THz signal emitted normal to the crystal surface is captured and imaged by two THz lenses 1122.

FIG. 23 shows another exemplary embodiment of a THz generation and extraction resonator geometry where the VECSEL cavity provides a single IR wavelength beam and the second IR wavelength is generated by an external laser source 1224 imaged on the nonlinear crystal 1202.

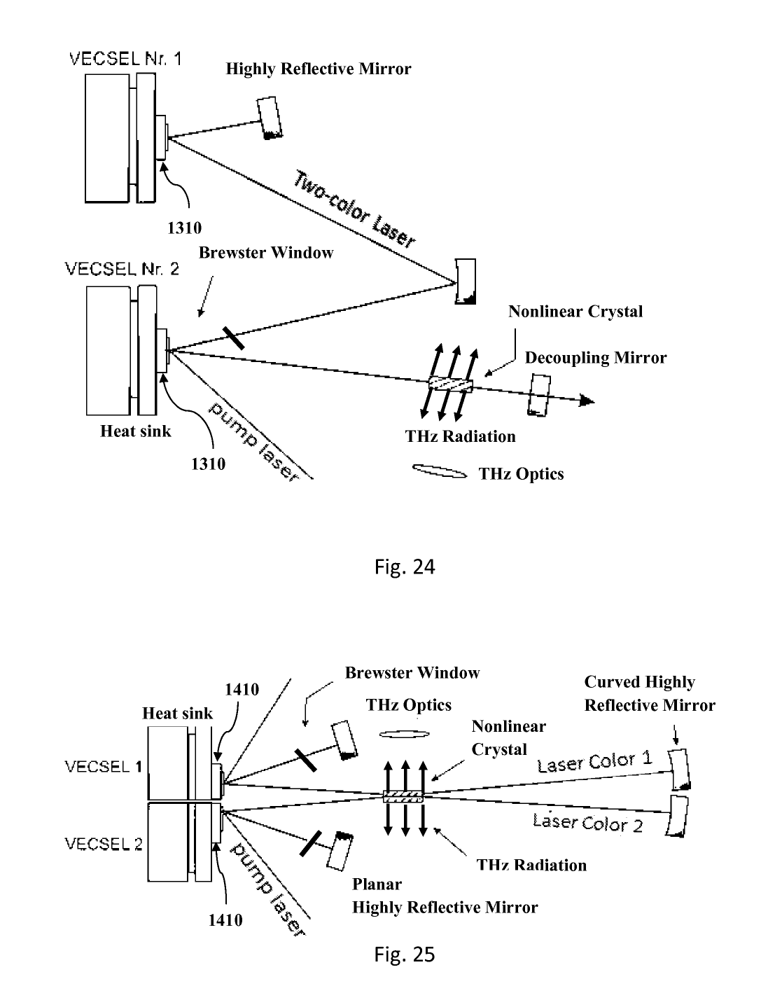

FIG. 24 shows a further exemplary embodiment of a THz generation and extraction resonator geometry where two VECSEL chips 1310 are combined in the resonator. This scheme offers many advantages. It provides additional intracavity IR power by cascading two dual-wavelength VECSEL chips 1310 in the cavity and/or the geometry allows for individual control on each VECSEL chip 1310 through temperature tuning of the wavelength. Additionally, individual VECSELs 1310 can be designed to have their peak gain at different wavelengths.

FIG. 25 shows still another exemplary embodiment of a THz generation and extraction system where again, two VECSEL chips 1410 are used but these now act as separate resonators with each generating its own IR wavelength. Both wavelengths are mixed in the common nonlinear crystal to generate the emission of THz waves.

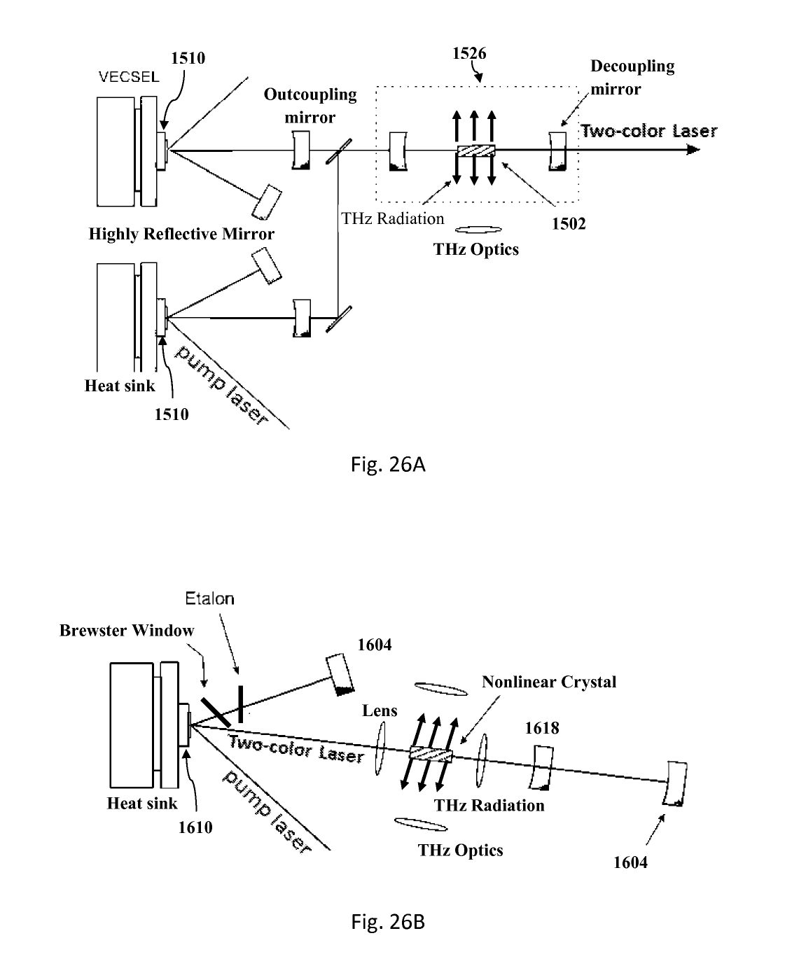

FIG. 26A shows an exemplary embodiment of another dual VECSEL cavity for the generation and extraction of THz waves. Here both VECSELs 1510 are combined in a common resonator 1526 with separate pump laser and cooling control enabling dual wavelength generation (individual wavelength from each chip 1510). The outcoupled dual wavelength IR light is combined into a single beam and coupled into a separate resonator where one (or more) nonlinear crystals 1502 for generating the THz signal is (are) placed.

FIG. 26B shows still another exemplary embodiment of a THz generation and extraction resonator where the dual wavelength IR light that is outcoupled through the 97% partial reflecting (3% transmission) mirror 1618 is fed back into the resonator by an external high reflectivity (100%) mirror 1604.

### THz Optics

The requirement for the THz optics is divided into three parts: initially, the THz radiation has to be efficiently outcoupled from the resonator, by separating it from the IR wave. Then, the radiation is to be extracted from the crystal in such a way that a minimum of reflection losses occurs. Subsequently, the THz waves may be formed by means of lens optics in such a way that a collimated beam results.

### Outcoupling of the Resonator

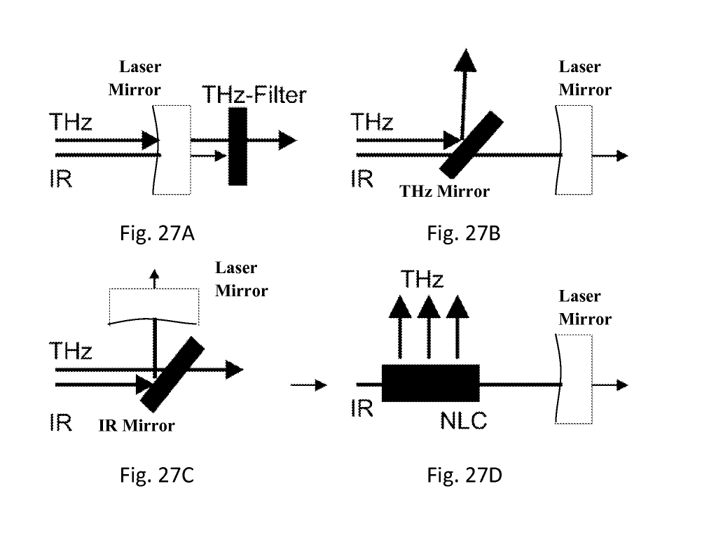

If the THz radiation is generated collinear to the resonator mode, it is able to be separated, according to the present invention, from the optical wave either within the resonator via a THz mirror, or the separation can occur behind the laser mirror, as depicted in FIG. 27A. For this purpose, the following possibilities are provided:

Behind the mirror, a filter which is transparent for THz radiation and absorbs or reflects the optical wave, is suitable for being used for separating both of the waves, FIG. 27A. This can be, for example, a polymer, a coated glass, or a semiconductor. Alternatively, a type of optical lattice is suitable for being used, which reflects the THz wave in another direction than the optical wave.

In order to separate the radiation within the cavity, a THz reflector, which is transparent for the optical wave, is suitable for being used. Here, for example, a glass coated with indium tin oxide (ITO) or with a dielectric THz mirror is provided. Alternatively, a material is suitable for being used, which comprises a high refraction index in the THz range and, thus, a high reflectivity, which is, however, only slightly reflective for the optical wave. This reflector is suitable for serving either only for the purpose of THz outcoupling or also for functioning as an etalon, in order to cause the spectral filtering of the laser lines.

Alternatively, a mirror which is highly reflective for the optical wave and slightly reflective and transparent in the THz range, is suitable for being applied within the cavity, FIGS. 17B, 17C.

If a crystal is chosen in which the THz generation occurs in such a way that the radiation is emitted from the crystal surface, the waves are automatically separated from one another, and no further separation measures are necessary. This is illustrated in FIG. 27D. This is a particularly preferable embodiment according to the present invention.

### THz Extraction Optics

Since many nonlinear crystals comprise a high refraction index, large reflection losses occur at the barrier layer between crystal and air, which reduce the useful output power of the system. In order to minimize these losses, THz anti-reflective (AR) coatings are applied to the crystal. This coating can comprise, for example, a polymer film or an oxide film, which features the usual thickness for AR coatings of one-quarter wavelength. Likewise, structuring of the crystal is possible: If holes, which are much smaller than the wavelength of the THz radiation, are introduced in the crystal in the region near the surface, then an effective refraction index is formed in this region. If this coating is adjusted respective to the wavelength, reflection minimization can hereby be achieved.

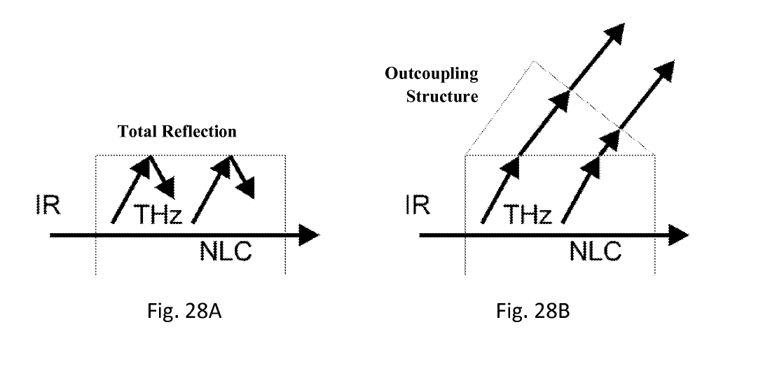

Furthermore, a large refractive index difference between crystal and air leads to an angle of the total reflection, i.e. the THz radiation, which exceeds a certain angle of incidence, is completely reflected at the boundary layer and, thus, becomes lost, FIG. 28A. In order to be able to use wave parts radiating obliquely onto the surface, a outcoupling structure according to the present invention is suitable for being used. This is depicted as an example in FIG. 28B. This outcoupling structure according to the present invention can comprise, for example, an obliquely cut crystal edge, a superimposed, obliquely cut coating, a superimposed prism or a prism-like surface structuring of the crystal.

### THz Lenses

Since the source of the THz radiation is a small generating area, the emitting wave comprises a large divergence. In order to be able to use the generated radiation in the most effective way possible, a collimation of the wave by means of THz lenses is desirable. Here, a lens design optimized on the wave form is to be chosen. If the THz wave is generated collinear, then this normally comprises a circular beam profile, so that spherical or aspherical lenses are suitable for beam shaping. If, however, a surface-emitting crystal is used, then the line-shaped generating area causes an elliptical beam profile: A large divergence occurs in one direction; in the other direction, the beam is already nearly collimated. In this case, a THz lens is to be used, which breaks with the circle symmetry. For example, a cylinder lens is suitable for being used as the first lens object.

Generally, it is possible to carry out a precollimation by means of a lens structure which is mounted directly on the crystal. This is also suitable for being combined with the AR coating. The precollimated wave is then suitable for being completely collimated through further lenses.

In order to image the wave onto a detector, THz lenses are again suitable for being used. In each case, the following lenses represent possible components for the system: spherical lenses, aspherical lenses, cylinder lenses, aspherical cylinder lenses, Fresnel lenses, and GRIN lenses.

### Crystals

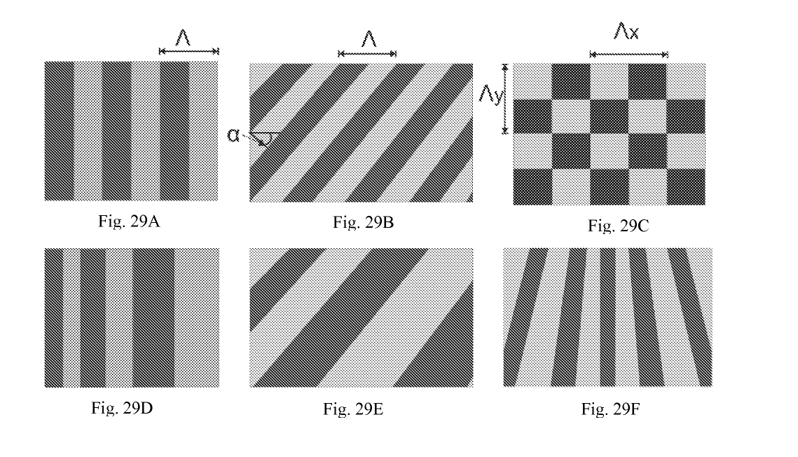

For efficient conversion, phase matching between the generated THz wave and the optical wave is to be achieved. In this, phase matching can be obtained either for a collinear wave expansion or for a noncollinear wave expansion. This can be achieved in different ways according to the present invention:
Via quasi phase matching: The ferroelectric crystal domains are poled one-, two- or multi-dimensionally. The polarity is to be matched periodically, aperiodically or in another way to the frequencies and emission direction used. In particular, a tilted/untilted periodic polarity, a tilted/untilted aperiodic polarity, a chessboard-shaped polarity, a fan-out polarity and a combination of these are suitable for being used. Examples are outlined in FIGS. 29A-29F (For clarification, the polarity period A 29A-B, the tilting angle of the polarity a 29B, and the two-dimensional polarities Λₓ and Λ_{y} 29C are depicted.).
Via birefringence: Many nonlinear crystals feature birefringent characteristics, i.e. the refraction index depends on the polarization direction of the electromagnetic wave relative to the crystal axes. Hereby, ordinary and extraordinary beams are differentiated. If a birefringent crystal is cut at a certain angle, then the effective refraction index of the extraordinary beam is able to change as a function of the cutting angle. Phase matching is to be achieved through this principle.
Nonlinear materials are suitable for being chosen, which fulfill phase matching without further modification.
Via waveguide structures: The nonlinear medium can be carried out in the form of a waveguide. Through this waveguide, guidance of the optical waves and/or the THz wave is able to occur. If all waves are guided, the design is to be realized in such a way that the effective group velocities of all waves are matched, i.e. the effective refraction indices vary from one another as little as possible. In order to realize this, all waveguide configurations described in textbooks are available (see e.g. Karl J. Ebeling, Integrierte Optoelektronik, Springer, Berlin, 1992.). Examples of this are raised strip waveguides, flushly embedded strip waveguides, buried strip waveguides, ridge waveguides, inverted ridge waveguides, dielectric slab waveguides, metal slab waveguides. However, countless further possibilities still result, since the nonlinear material (or the nonlinear materials) is (are) suitable for being combined with other materials as well, which comprise a very small or negligible nonlinear coefficient, but a refraction index suitable for achieving phase matching, for the realization of a waveguide. Generally, in order to achieve phase matching through wave guidance, a structured or unstructured nonlinear crystal or a combination of one or several structured or unstructured nonlinear media and other structured or unstructured materials is suitable for being used.
Additionally, waveguides and/or nonlinear materials, which comprise photonic crystal structures or depend on so-called metamaterials with a negative refraction index, are also possible.

All substances which comprise a nonlinear coefficient are suitable as materials. For optimal conversion efficiency, the material should possess a maximal nonlinear coefficient and a minimal absorption in the THz range. There are also materials suitable which allow nonlinear mixtures of a higher order, for example four-wave mixture or five-wave mixture.

In particular, the following materials are available as a nonlinear medium. Hereby, these are suitable for being used either in pure form or doped. These are also, optionally, to be provided with a QPM, to be cut at a certain angle or to be structured as a waveguide:
Lithium niobate (LiNbO₃) in congruent and stoichiometric form. This material is suitable for being provided with a QPM particularly efficiently. In particular, periodically poled lithium niobate (PPLN), tilted periodically poled lithium niobate (TPPLN), aperiodically poled lithium niobate (APPLN), tilted aperiodically poled lithium niobate (TAPPLN), chessboard-shaped poled lithium niobate and lithium niobate with a fan-out polarity are suitable.
Another embodiment is an unstructured lithium niobate crystal, which is provided with an outcoupling structure, in order to use THz irradiation under the Cherenkov angle.
In order to reduce the photorefractive effect, these embodiments are suitable for being doped with other substances, for example with magnesium oxide (MgO) or manganese (Mn).
GaAs.
Zinc germanium diphosphide (ZGP, ZnGeP₂), silver gallium sulfide and selenide (AgGaS₂ and AgGaSe₂), and cadmium selenide (CdSe)
ZnSe
GaP
GaSe
Lithium tantalate (LiTaO₃)
Lithium triborate
Potassium niobate (KNbO₃)
Potassium titanyl phosphates (KTP, KTiOPO₄)
All materials from the “KTP family” and also KTA (KTiOAsO₄), RTP (RbTiOPO₄) and RTA (RbTiAsPO₄), are likewise suitable for being periodically poled
Potassium dihydrogen phosphate (KDP, KH2PO4) and potassium dideuterium phosphate (KD*P, KD₂PO₄)
Beta barium borate (beta-BaB₂O₄=BBO, BiB₃O₆=BIBO), and cesium borate (CSB₃O₅=CBO), lithium triborate (LiB₃O₅=LBO), cesium lithium borate (CLBO, CsLiB₆O₁₀), strontium beryllium borate (Sr₂Be₂B₂O₇=SBBO), yttrium calcium oxyborate (YCOB) and K₂Al₂B₂O₇=KAB
Organic nonlinear media, in particular DAST.
Nonlinear media on a polymer basis, for example electro-optical polymers, in particular, all compounds which comprise amorphic polycarbonates or phenyltetraenes.
Silicon or strained silicon
Furthermore, all semiconductor materials, in strained or unstrained form, which comprise a non-disappearing, nonlinear χ-coefficient.

The crystals can be designed in such a way that the THz irradiation occurs collinear or noncollinear to the optical waves. Hereby, the crystals can be provided with THz-anti-reflective and/or outcoupling structures in order to better extract the generated waves from them.

The current prototype has been examined in CW operation, since the VECSEL is continuously pumped and neither an active nor a passive element is located within the resonator which would enable a pulsed emission

In a further embodiment, the simplest possibility for operating the device in a pulsed manner consists in pulsing the pump laser, in order to finally obtain a higher intracavity power.

Further possibilities for running the VECSEL in pulse operation, especially regarding the generation of considerably shorter pulses and, thus, significantly higher intensities, comprises the application of active or passive elements, which are hereinafter described:

An active element can be incorporated in the resonator, e.g. a Q switching, in order generate pulses in the range of nanoseconds or picoseconds.

In order to achieve even shorter pulses in the range of femtoseconds, e.g. a saturable absorber can be integrated into the resonator as a passive element. These ultrashort pulses are achieved by means of the so called mode coupling.

Several publications and patent documents are cited in this application in order to more fully describe the state of the art to which this invention pertains. The disclosure of each of these citations is incorporated by reference herein.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention as set forth in the claims.

1. A multi-wavelength vertical external cavity surface emitting laser system, comprising:
at least one laser chip having an intrinsically broadened active region;
an external cavity in optical communication with the laser chip to receive optical radiation emitted by the laser chip and configured to support lasing;
a wavelength selective filter in optical communication with the laser chip, the wavelength selective filter configured to provide a laser that oscillates at two or more separated wavelengths simultaneously; and
a nonlinear medium disposed within the cavity for receiving optical radiation of the two or more separated wavelengths, the nonlinear medium configured to emit radiation at a frequency that is the difference of the frequencies associated with two of the separated wavelengths.

2. (canceled)

3. A multi-wavelength laser system according to claim 1, wherein the nonlinear medium is configured to emit terahertz radiation.

4. A multi-wavelength laser system according to claim 1, wherein the nonlinear medium comprises lithium niobate.

5. A multi-wavelength laser system according to claim 4, wherein the nonlinear medium comprises a periodically poled material.

6. A multi-wavelength laser system according to claim 5, wherein the nonlinear medium is configured to emit terahertz radiation in the range of about 100 GHz to about 10 THz.

7. A multi-wavelength laser system according to claim 1, wherein the wavelength selective filter is disposed within the cavity.

8. A multi-wavelength laser system according to claim 1, wherein the wavelength selective filter is configured to permit tuning of the two of the separated wavelengths.

9. A multi-wavelength laser system according to claim 8, wherein the orientation of the wavelength selective filter is movable relative to the optical axis of the laser to effect the tuning.

10. A multi-wavelength laser system, comprising:
at least two laser chips having different emission wavelengths to permit laser oscillation at two separated wavelengths simultaneously;
an external cavity in optical communication with the at least two laser chips to receive optical radiation emitted by the at least two laser chips and configured to support simultaneous lasing at the two separated wavelengths; and
a nonlinear medium disposed within the cavity for receiving optical radiation of the two or more separated wavelengths, the nonlinear medium configured to emit radiation having a frequency that is the difference of the frequencies associated with two of the separated wavelengths.

11. A multi-wavelength laser system according to claim 10, wherein at least one of the two laser chips provides a vertical external cavity surface emitting laser.

12. A multi-wavelength laser system according to claim 10, wherein at least one of the two laser chips comprises a disk laser.

13. (canceled)

14. A multi-wavelength laser system according to claim 10 or 11, wherein the nonlinear medium is configured to emit terahertz radiation.

15. A multi-wavelength laser system according to claim 10 or 11, wherein the nonlinear medium comprises lithium niobate.

16. A multi-wavelength laser system according to claim 15, wherein the nonlinear medium comprises a periodically poled material.

17. A multi-wavelength laser system according to claim 16, wherein the nonlinear medium is configured to emit terahertz radiation in the range of about 100 GHz to about 10 THz.

18. A method for creating lasing in a vertical external cavity surface emitting laser using difference frequency generation, comprising:
providing at least one laser chip having an intrinsically broadened active region;
providing an external cavity in optical communication with the laser chip to receive optical radiation emitted by the laser chip and configured to support lasing;
providing a wavelength selective filter within the external cavity, the wavelength selective filter configured to provide a laser that oscillates at two or more separated wavelengths simultaneously; and
providing a nonlinear medium disposed within the cavity for receiving optical radiation of the two or more separated wavelengths, the nonlinear medium configured to emit radiation having a frequency that is the difference of the frequencies associated with two of the separated wavelengths.

19. (canceled)

20. The method according to claim 18, wherein the nonlinear medium is configured to emit terahertz radiation.

21. The method according to claim 18, wherein the nonlinear medium comprises lithium niobate.

22. The method according to claim 21, wherein the nonlinear medium comprises a periodically poled material.

23. The method according to claim 22, wherein the nonlinear medium is configured to emit terahertz radiation in the range of about 100 GHz to about 10 THz.

24. The method according to claim 18, tilting the wavelength selective filter relative to the optical axis of the laser to effect the tuning.

25. (canceled)

26. A multi-wavelength laser according to claim 1, wherein the wavelength selective filter comprises a Fabry-Perot etalon.

27. A multi-wavelength laser according to claim 1 or claim 26, wherein the external cavity comprises a V-shaped cavity or a linear cavity.

28. A multi-wavelength laser according to claim 1 or claim 26, wherein the external cavity comprises a Z-shaped cavity.

29. A multi-wavelength laser according to claim 1 or claim 26, wherein the wavelength selective filter is oriented within the cavity at an angle that directs wavelengths of radiation reflected by the filter external to the cavity.

30. A multi-wavelength laser according to claim 1 or claim 26, comprising a Brewster window disposed within the external cavity and configured to narrow the line-width of the laser.

31. (canceled)

32. A method according to claim 18 Error! Reference source not found., comprising orienting the wavelength selective filter within the cavity at an angle that directs wavelengths of radiation reflected by the filter external to the cavity.

33. A method according to claim 18 Error! Reference source not found., comprising providing a Brewster window disposed within the external cavity and configured to narrow the line-width of the laser.
